(19) United States
(12) Patent Application Publication
(10) Pub. No.: US 2026/0179060 A1
(43) Pub. Date: Jun. 25, 2026

(54) Programmed Analytical System for Hate, Intimidation, and Bias Incidents

(71) Applicant: Steven BARANOWITZ, Wyncote, PA (US)

(72) Inventor: Steven BARANOWITZ, Wyncote, PA (US)

(21) Appl. No.: 19/366,931

(22) Filed: Oct. 23, 2025

Related U.S. Application Data
(60) Provisional application No. 63/713,675, filed on Oct. 30, 2024.

(51) Int. Cl. G06Q 10/40; G06F 3/0482; G06F 16/9535; G06Q 10/06; G06Q 10/067; G06Q 10/10

(52) U.S. Cl. CPC G06Q 10/40; G06F 3/0482; G06F 16/9535; G06Q 10/06; G06Q 10/067; G06Q 10/10

(57) ABSTRACT

The application relates to systems and methods for classification of incidents and speech related to hate, intimidation, and bias against any group (e.g., racial, ethnic, religious, political), and incorporates methods to support decisions related to intervention, mitigation, and defense against such activities and speech.

### CROSS-REFERENCE TO RELATED APPLICATIONS

This application claims priority to U.S. Patent Application No. 63/713,675, titled, “Programmed Analytical System for Hate, Intimidation, and Bias Incidents,” which is herein incorporated by reference in its entirety. This application further incorporates by reference U.S. Ser. No. 63/458,177 filed Apr. 10, 2023, and U.S. Ser. No. 63/526,211, filed Jul. 12, 2023, in their entireties.

### BACKGROUND

The present disclosure is directed to a system and methodology for description, analysis, tracking, classification, assessment, and prediction of incidents and speech related to hate, intimidation, and bias against any group (e.g., racial, ethnic, religious, and/or political group), and incorporates methods to support decisions related to intervention, mitigation, and defense against such activities and speech.

There is no generally accepted method for accurately describing and predicting short- and long-term trends in incidents and speech related to hate, intimidation, and bias. Review of the literature and personal communications with researchers and thought leaders in this area confirmed this state of affairs.

In general terms, each organization, whether government, private, nonprofit, or other non-governmental organization, uses methods such as non-validated questionnaires, data mining from social media websites, law enforcement reports, etc. resulting in a highly variable mass of data on any specific topic such as antisemitism, racially motivated hate crimes, etc.

In particular, most published reports about such incidents and speech activities, often make pairs of year-to-year comparisons or locality to locality comparisons with little or no discussion on what trends for the future may be elicited from the limited data currently reported. Wheeler discusses the limitations and tendency to misrepresent situations generated by pairs of year-to-year comparisons of data, such as are commonly seen in this field, and states bluntly, “Stop reporting comparisons between pairs of values except as part of a broader comparison.” (Understanding Variation: The Key to Managing Chaos. 2000. by Donald J. Wheeler, SPC Press, Knoxville, TN, p. 13).

All references cited herein are incorporated herein by reference in their entireties.

### BRIEF SUMMARY

The inventor, having considered this state of affairs unsatisfactory, has invented systems and methods for quantitatively describing and predicting the trends and specific numbers of incidents and activities in a highly useful way which can be directed towards supporting decisions on intervening, mitigating, and defending against hate, intimidation and bias.

Currently there exists a need to provide systems and methods for description, analysis, tracking, and prediction of incidents and speech related to hate, intimidation, and bias against any group (e.g., racial, ethnic, religious, and/or political group), and incorporate these systems and methods to support decisions related to intervention, mitigation, and defense against such activities and speech. The disclosure provides a solution to this problem by providing creation and adaptation of certain mathematical ranking and statistical methods which have yielded surprising insightful, meaningful, and practical methods of analyzing, tracking, and predicting hate, intimidation, and bias actions and speech.

Further, there exists a need for rapid, real-time (or near real-time), objective, standardized ranking, assessment, and analysis of the severity of hate, intimidation, and bias incidents as they occur, so that resources from law enforcement and other agencies can respond to document and mitigate these incidents and perhaps prevent their escalation. The disclosure provides a programmed analytical system for Hate, Intimidation, and Bias Incidents (HIBI), including a classification assistant (CA) module, a ranking (RANK) module, a bias module (BIAS), a decide module (DECIDE), and an ASAZ module, that provides standardized, objective evaluation. To date, in order to rank or score an incident requires a person who has had some training in use of these modules, and the time to do the ranking. However, this can be insufficient when considering a rapidly evolving situation, such as a protest that may progress from a few individuals holding signs, to shouted curses, to obstruction of entry, to assault, property damage, or murder. To address these situations, the disclosure provides a real-time or near real-time tool for scoring and ranking, in a semi-automated or fully automated manner, that speeds up this analysis. Reports made through, for example, smartphone applications, could result in hundreds of reports of incidents in a short period of time. The HIBI-CA module fulfills the need to speed up the process of analyzing such incidents and data by providing a series of algorithms, which can be used individually, sequentially, or in any combination, to rank and assess incidents, as described further herein.

The disclosure provides a method for classification of incidents and speech related to hate, intimidation, and bias against a person or group subject to bias, the method comprising: receiving data related to incidents and/or speech related to hate, intimidation, and/or bias against a person and/or group subject to bias; performing one or more steps including: extracting sentences previously classified in a data repository of historical incident data from the received data, extracting phrases and/or keywords previously classified in the data repository of historical incident data from the received data, removing duplicates in the received data, extracting keywords and phrases that are not found in the data repository, identifying nouns and verbs in the received data, constructing a word frequency table from the received data and/or a portion of the received data remaining after one or more of the above steps are performed, or any combination thereof. The disclosure provides a method for classification of incidents and speech related to hate, intimidation, and bias against a person or group subject to bias, further comprising: ranking and/or scoring the incidents and/or speech, of the received data, based on one or more outputs of the one or more steps. The disclosure provides a method for classification of incidents and speech related to hate, intimidation, and bias against a person or group subject to bias, wherein the received data includes a description of the incidents and/or speech related to hate, intimidation, and/or bias against a person and/or group subject to bias. The disclosure provides a method for classification of incidents and speech related to hate, intimidation, and bias against a person or group subject to bias, further comprising: analyzing the description of the incidents and/or speech related to hate, intimidation, and/or bias to identify patterns, trends, and/or relationships between incidents and/or speech related to hate, intimidation, and/or bias against a person and/or group subject to bias. The disclosure provides a method for classification of incidents and speech related to hate, intimidation, and bias against a person or group subject to bias, wherein analyzing the description to identify patterns, trends, and/or relationships includes applying mathematical modeling. The disclosure provides a method for classification of incidents and speech related to hate, intimidation, and bias against a person or group subject to bias, wherein analyzing the description to identify patterns, trends, and/or relationships includes applying a machine learning model. The disclosure provides a method for classification of incidents and speech related to hate, intimidation, and bias against a person or group subject to bias, wherein the step of analyzing the description of incidents and speech related to hate, intimidation, and bias against a person or group subject to bias further comprises using mathematical decision analysis techniques. The disclosure provides a method for classification of incidents and speech related to hate, intimidation, and bias against a person or group subject to bias, wherein the step of analyzing the description of incidents and speech related to hate, intimidation, and bias against a person or group subject to bias further comprises using non-parametric tests selected from the group consisting of a Wilcoxon signed rank test, a Plackett-Luce model, and others. The disclosure provides a method for classification of incidents and speech related to hate, intimidation, and bias against a person or group subject to bias, wherein the step of analyzing the description of incidents and speech related to hate, intimidation, and bias against a person or group subject to bias further comprises using parametric tests selected from the group consisting of the Gompertz equation, and the shifted Gompertz equation. The disclosure provides a method for classification of incidents and speech related to hate, intimidation, and bias against a person or group subject to bias, further comprising: using the identified patterns, trends, and/or relationships to predict future changes in incidents and/or speech related to hate, intimidation, and/or bias against a person and/or group subject to bias. The disclosure provides a method for classification of incidents and speech related to hate, intimidation, and bias against a person or group subject to bias, wherein the step of using the identified patterns, trends, and relationships to predict future changes in incidents and speech related to hate, intimidation, and bias against a person or group subject to bias further comprises providing a confidence level for the predicted future changes in incidents and speech related to hate, intimidation, and bias against a person or group subject to bias. The disclosure provides a method for classification of incidents and speech related to hate, intimidation, and bias against a person or group subject to bias, further comprising: tracking changes in incidents and/or speech related to hate, intimidation and/or bias against a person and/or group subject to bias over time. The disclosure provides a method for classification of incidents and speech related to hate, intimidation, and bias against a person or group subject to bias, further comprising: generating recommendations for interventions to mitigate the effects of incidents and/or speech related to hate, intimidation, and/or bias on a person and/or group subject to bias. The disclosure provides a method for classification of incidents and speech related to hate, intimidation, and bias against a person or group subject to bias, wherein the step of generating recommendations for interventions further comprises providing recommendations for interventions based on the predicted future changes in incidents and speech related to hate, intimidation, and bias against a person or group subject to bias. The disclosure provides a method for classification of incidents and speech related to hate, intimidation, and bias against a person or group subject to bias, further comprising: generating recommendations for defending against incidents and/or speech related to hate, intimidation and/or bias. The disclosure provides a method for classification of incidents and speech related to hate, intimidation, and bias against a person or group subject to bias, wherein the step of generating recommendations for defending against incidents and speech related to hate, intimidation, and bias further comprises providing recommendations for defending against incidents and speech related to hate, intimidation, and bias based on the predicted future changes in incidents and speech related to hate, intimidation, and bias against a person or group subject to bias. The disclosure provides a method for classification of incidents and speech related to hate, intimidation, and bias against a person or group subject to bias, wherein the person or group subject to bias is subject to bias based upon age, race, ethnicity, religion, gender, sexual orientation, disability, socio-economic status or familial socio-economic status, citizenship status, association with institutions such as schools, charities, political organization, etc. The disclosure provides a method for classification of incidents and speech related to hate, intimidation, and bias against a person or group subject to bias, wherein the step of receiving data further comprises receiving data from multiple sources, including but not limited to sensors, databases, and external data feeds.

### BRIEF DESCRIPTION OF SEVERAL VIEWS OF THE DRAWINGS

The invention will be described in conjunction with the following drawings in which like reference numerals designate like elements and wherein:

FIG. 1 is a chart showing Antisemitic incidents in the US from 2013-2022.

FIG. 2 is a chart showing the Cumulative (Running Total) Counts of ADL Heatmap Antisemitic Incidents Data.

FIG. 3 is a chart showing a Mathematical Model with ADL Data Points on Antisemitic Incidents.

FIG. 4 is a chart showing a Comparison of Mathematical Model with ADL Data Points on Antisemitic Incidents.

FIG. 5 is a chart showing a Mathematical Model of ADL Heatmap Incidents Data with Predictions to 2030.

FIG. 6 is a chart showing a Mathematical Model of ADL Heatmap Propaganda Data.

FIG. 7 is a chart showing a Mathematical Model of ADL Heatmap Propaganda Data with Prediction to 2030.

FIG. 8 is a chart showing a Cumulative (Running Total) Counts of ADL Heatmap Events Data.

FIG. 9 is a chart showing a Mathematical Model of ADL Heatmap White Supremacist Events Data with Prediction to 2030.

FIG. 10 is a chart showing mass shooting data fitted with the predictive modeling as disclosed herein.

FIG. 11 is a chart showing an excerpt from an ADL List of Incidents.

FIG. 12A is a KM Macro to Import Data and Run Gompertz in JMP;

FIG. 12B is a KM Macro: To Save Gompertz Predictors+1stDeriv+GraphPlot Activate JMP Pro 15.

FIG. 13 is block diagram showing an exemplary hate, intimidation, and bias incident (HIBI) classification assistant (CA) module for a Hate, Intimidation, and Bias Incident (HIBI) analysis system.

FIG. 14 illustrates an exemplary Algorithm 1 of a HIBI-CA module.

FIG. 15 illustrates an exemplary Algorithm 2 of a HIBI-CA module.

FIG. 16 illustrates an exemplary Algorithm 3 of a HIBI-CA module.

FIG. 17 illustrates an exemplary Algorithm 4 of a HIBI-CA module.

FIG. 18 illustrates an exemplary Algorithm 5 of a HIBI-CA module.

FIG. 19 illustrates an exemplary Algorithm 6 of a HIBI-CA module.

FIG. 20 illustrates a sample run of Algorithm 1 of a HIBI-CA module.

FIG. 21 illustrates a sample run of Algorithm 2 of a HIBI-CA module.

FIG. 22 illustrates a sample run of Algorithm 3 of a HIBI-CA module.

FIG. 23 illustrates a sample run of Algorithm 4 of a HIBI-CA module.

FIG. 24 illustrates a sample run of Algorithm 5 of a HIBI-CA module.

FIG. 25 illustrates a sample run of Algorithm 6 of a HIBI-CA module.

### DETAILED DESCRIPTION

This disclosure is directed to systems and methods for description, analysis, tracking, classification, prediction, and assessment of incidents and speech related to hate, intimidation, and bias against any group (e.g., racial, ethnic, religious, and/or political group), and incorporate these systems and methods to support decisions related to intervention, mitigation, and defense against such activities and speech.

### Analysis

Examples of the components of the system and methodology include regression analysis of periodic (e.g., monthly or yearly) data, a novel ranking system for incidents and speech of a defined type, and the use of non-parametric and other statistical methods, artificial intelligence and machine learning techniques to support actionable decisions.

One commonly used method for assessing threat levels is to determine people's attitudes toward the environment in which they live. This is today done in heterogeneous ways. In contrast, there are “validated” questionnaires which have been rigorously tested in industries, such as the pharmaceutical industry, and governmental bodies, such as FDA, for which there is a high degree of confidence in their meaningfulness. The inventor has found that “validated” questionnaires such as anxiety questionnaires (see below) can be adapted for the purpose of accurately and reproducibly assessing a population's worry and anxiety level regarding hate, intimidation, and/or bias toward attacks or incidents (e.g., including attacks on people, vandalism, and harassment), to set a new standard for data collection.

For describing and predicting such types of attitudes, activities, and behavior, the author has created a new system and methodology. This system and methodology, which includes several forms of mathematical modeling, is linked to mathematical decision analysis techniques and methodologies to support making actionable decisions to mitigate and defend against harmful behavior.

For example, historically, there has been no good system for comparing quantitatively the severity of antisemitic events, or to objectively, meaningfully and statistically compare threat “environments” in different locations such as two different US states. The disclosure provides a system and methodology which makes meaningful and objective quantitation possible.

### Ranking

A ranking system of severity of events (and/or speech) such as shown in Example 4 is devised with the advice of experts consulted or focus group responses evaluated, as examples. Frequencies of each component of the ranking system are obtained from each location by the use of validated questionnaires, police reports, government reports, non-governmental organization reports and databases, etc. This ranking system can be used to objectively compare different localities (as in this example), or different years, either by a scoring system as shown, or by statistic methods such as, for example, non-parametric tests (e.g., Wilcoxon signed rank test, Plackett-Luce model or others). Non-parametric tests, also known as distribution-free tests, are statistical tests that do not make assumptions about the underlying distribution of the data. These tests are used when the data do not meet the assumptions required for parametric tests, such as a normal distribution or equal variances. Non-parametric tests are often preferred in situations where the data are ordinal, skewed, or have outliers. They provide a way to analyze data without making strong assumptions about its distribution or shape. Exemplary non-parametric tests include, but are not limited to: Mann-Whitney U test (also known as Wilcoxon rank-sum test): It is used to compare the distributions of two independent groups and determine if there is a significant difference between them; Kruskal-Wallis test: This test is an extension of the Mann-Whitney U test and is used when comparing more than two independent groups. It determines if there is a significant difference in the medians of the groups; Wilcoxon signed-rank test: It is used to compare two related samples or matched pairs. It determines if there is a significant difference between the paired observations; Friedman test: This test is an extension of the Wilcoxon signed-rank test and is used when comparing more than two related samples. It determines if there is a significant difference in the medians of the related groups; Chi-square test: This test is used to examine the association between two categorical variables. It determines if there is a significant difference between the observed and expected frequencies; and Fisher's exact test: It is used to analyze the association between two categorical variables when the sample size is small. It determines if there is a significant association between the variables.

The Wilcoxon signed rank test is a non-parametric statistical test used to compare two related or paired samples. It is used to determine if the median of the difference between paired observations is significantly different from zero. The test is called “signed rank” because it involves ranking the absolute values of the differences between paired observations, and then assigning positive or negative signs to each rank based on the direction of the difference. The signed ranks are then summed to obtain a test statistic, which is compared to a critical value from a reference distribution. The Wilcoxon signed rank test is useful when the assumptions of a paired t-test are not met, such as when the data is not normally distributed or the variances are not equal. It is also useful when the data is measured on an ordinal scale or when outliers are present. To conduct a Wilcoxon signed rank test, the steps are, for example, as follows: State the null and alternative hypotheses; Rank the absolute differences between the paired observations.; Assign a positive or negative sign to each rank based on the direction of the difference; Calculate the sum of the signed ranks; Determine the critical value for the test from a reference table or software; Compare the test statistic to the critical value and make a decision about the null hypothesis. Report the results of the test, including the test statistic, the critical value, and the p-value.

The Plackett-Luce model assumes that there are K items that are being ranked by N individuals. Each individual ranks the items from best to worst, and these rankings are used to estimate the probabilities of each item being ranked first. The Plackett-Luce model assumes that the probability that an item is ranked first is proportional to its weight, or utility, which is a positive parameter for each item. The sum of the weights for all items is set to one, which ensures that the probabilities of all items being ranked first sum to one. The Plackett-Luce model can be estimated using maximum likelihood estimation or Bayesian methods. The maximum likelihood method involves finding the set of weight parameters that maximize the likelihood of the observed rankings, given the model assumptions. The Bayesian method involves specifying prior distributions on the weight parameters and updating them based on the observed rankings. The Plackett-Luce model has several applications, including in marketing research, sports ranking, and recommender systems. It can be extended to account for ties in the rankings, partial rankings, or other sources of heterogeneity among individuals. The Plackett-Luce model is a useful tool for analyzing ranking data and understanding the preferences and utilities of individuals for different items.

In certain embodiments as disclosed herein, the ranking system as disclosed herein can be used to objectively compare different localities, or different years, either by a scoring system as shown, or by statistic methods such as, for example, parametric tests. Parametric modeling refers to the use of mathematical equations or models that contain a fixed set of parameters to describe and analyze a system, process, or relationship between variables. In parametric modeling, specific assumptions are made about the functional form or distribution of the data being modeled, and the parameters of the model are estimated from the available data. There are numerous parametric modeling equations, some commonly used parametric modeling equations include, for example, Linear regression equation, Non-linear regression equation, Polynomial regression equation, Exponential growth equation, Logistic growth equation, Power law equation, Weibull distribution equation, the Gompertz equation, and the shifted Gompertz equation.

Machine learning algorithms are mathematical models that are designed to learn from data and make predictions or decisions without being explicitly programmed. These algorithms are trained on large sets of data, using statistical methods to identify patterns and relationships, and then use this information to make predictions or decisions on new data. There are many different types of machine learning algorithms, each with its own strengths and weaknesses. Some common types of machine learning algorithms include:

Supervised Learning Algorithms: These algorithms are used for tasks such as classification and regression, where the goal is to predict a target variable based on input variables. Examples include Linear Regression, Non-linear Regression, Logistic Regression, Decision Trees, Random Forests, and Support Vector Machines.

Unsupervised Learning Algorithms: These algorithms are used for tasks such as clustering and dimensionality reduction, where the goal is to discover patterns or groupings in the data. Examples include K-Means Clustering, Hierarchical Clustering, Principal Component Analysis, and t-SNE.

Reinforcement Learning Algorithms: These algorithms are used for tasks such as game playing and robot control, where the goal is to learn an optimal policy for taking actions in an environment. Examples include Q-Learning and Deep Reinforcement Learning.

Overall, machine learning algorithms are an important tool for solving complex problems and making predictions in a variety of domains, including finance, healthcare, threat analysis, and social media analysis.

The disclosure provides the development of high-quality validated questionnaires for antisemitism and other hate/bias activities and speech by adapting questionnaires such as the Anxiety Symptoms Questionnaire (Baker A, Simon N, Keshaviah A, et al. Anxiety Symptoms Questionnaire (ASQ): development and validation. General Psychiatry 2019; 32:e100144. doi) or the Athlete Fear Avoidance Questionnaire (Dover, G. and Amar, V. Development and validation of the athlete fear avoidance questionnaire. Journal of Athletic Training 2015; 50 (6): 634-642 doi: 10.4085/1062-6050-49.3.75) to antisemitism, racial hate environments, etc.

A problem addressed by the present disclosure is that today, many databases are repositories of incidents or items which are either not categorized, or only broadly categorized into such wide categories as to be not amenable to meaningful statistical analysis.

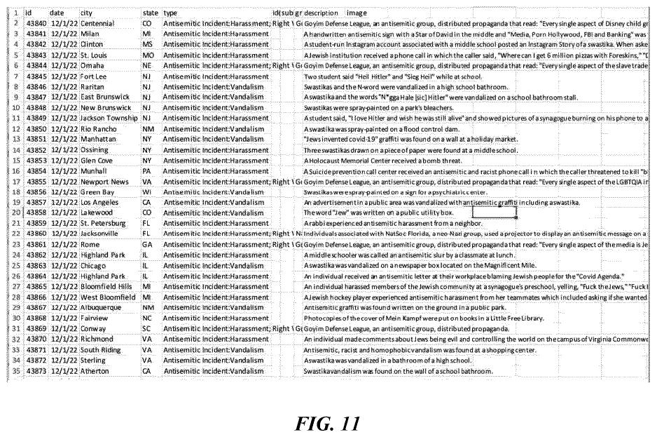

For example, the ADL HEATMAP website (see www.adl.org/resources/tools-to-track-hate/heat-map) has publicly available a database which documents antisemitic actions and speech. A screenshot is provided in FIG. 11 of a small portion of the database which had been accessed 25 Jun. 2023, and provides a sample of the great heterogeneity of the nature and seriousness of the items in the database.

While a variety of ranking systems and categorizations can be devised, disclosed herein is a system that will overcome the problem as set forth above to aid in detailed description categorization and comparison of items and incidents that occur. This will also permit comparison of different locations and at different times. This ranking system is amenable to analysis and comparison in time and locations for either a scoring system, or more sophisticated methods such as Plackett-Luce, or other methods as disclosed herein.

The items under consideration are assigned to one of four main categories: Persons, Movements, Property, and Speech.

This method accounts for their relative importance by assigning these categories relative weights for scoring purposes, for example, 8 for Persons, 4 for Movement, 2 for Property, 1 for Speech.

A sample description of items to be included in each category is provided in Example 7. (Note that for the Person and Property categories, the subcategories are adapted from Berzofsky's list of FBI categorizations: Marcus Berzofsky et al., 2022. Indicators for Crime Estimates Using NIBRS Data. bjs.ojp.gov/content/pub/pdf/iceunibrsd.pdf Accessed Jul. 3, 2023).

For a given county (or city, or state, or country) the number of each type of incident (=frequency) is recorded each year. For each type of incident, the frequency is multiplied by the rank number (in one of the 4 main categories) and then is multiplied by the weight of that category. Then all these subtotals are tallied up to give a score for that county. The scores of different counties and at different times can be compared quantitatively.

### Ranking System for Bias Indicators for Classification of Hate Crimes (HIBI-RANK Module)

For something to be classified as a hate crime, the motivation for the action must be confirmed to be biased (Pezzella, Frank S., et al. 2019. The Dark Figure of Hate Crime Underreporting. American Behavioral Scientist, 2019, p. 1-24. doi.org/10.1177/000276421882384). Pezzella et al., 2019 list several characteristics that FBI uses to make this determination. Provided herein is a modification and adaptation of this listing into a practical ranking/scoring system which is useful to make this important determination in a quantitative and straight-forward manner.

For each incident the person investigating the incident (e.g., police officer or FBI agent) would check off which items apply to that incident. Each verified item would be multiplied by its rank number (R# below), and then the total score would be calculated. If the total exceeds a previously agreed upon threshold, then the incident would be classified as due to hate bias.

In some implementations of the ranking system, hate, intimation, and/or bias incidents can have components of one or more of the following categories: A) Incidents involving injury to persons, B) Incidents involving mass movements of people, C) Incidents involving property, D) Incidents involving speech.

### Modeling System

Disclosed herein is a method using, for example, the Gompertz equation, which is effective in describing events quantitatively over time, and which enables comparison in different time periods and different locations, and to quantitatively forecast future events based on those trends.

As further disclosed herein, methods using the Shifted Gompertz equation as an example model can be used to quantitatively and qualitatively characterize the appeal of an idea or behavior, and the resistance in a population (or individual) to accepting that idea or behavior.

The Shifted Gompertz (SG) equation is a variant of the regular Gompertz equation. It is said to fit a wider variety of data sets than the regular Gompertz equation and has primarily found use in describing marketing of new products and services. The Shifted Gompertz equation is a mathematical model that describes the growth or decay of a variable over time, which is derived from the original Gompertz function by introducing a shift parameter that allows for a time delay in the growth or decay process. The SG equation has shown to be better at forecasting than competing models such as the Bass model and the Weibel model, for a number of different datasets (Bemmaor, Albert C. & Zheng, Li, 2018. “The diffusion of mobile social networking: Further study,” International Journal of Forecasting, Elsevier, vol. 34 (4), pages 612-621; Bauckhage, Christian & Kersting, Kristian. (2014). Strong Regularities in Growth and Decline of Popularity of Social Media Services. doi.org/10.48550/arXiv.1406.6529. others).

As disclosed herein the parameters of this equation have been reinterpreted to be broadly applicable to a societal context, so that they are meaningful as regards the spread of new ideas and/or behaviors. Changes in certain of these parameters enable the investigator to measure the effectiveness of interventions in slowing the spread of new ideas including anti-Semitic propaganda and of behaviors such as the convening of neo-Nazi rallies. The disclosure provides the development of customized automated and thus more efficient and real-time programming implementations of the regular Gompertz equation and the Shifted Gompertz equation to make their use more accessible, more widely applicable, and more practical.

The SG equation was defined by Bemmaor (1994) and its mathematical and statistical properties have been reported by a number of investigators including Meade and Islam (2006), Jimenez and Jodra (2009) and Torres (2014). (Meade, N and Islam, T. Modelling and forecasting the diffusion of innovation—A 25-year review. International Journal of Forecasting, 2006, Vol. 22 (3), p. 519-545). In particular, it is considered a subset of the more general Gamma/Shifted Gompertz equation, where the alpha parameter is infinite; Jiménez, F. and Jodrá, P. (2009). A Note on the Moments and Computer Generation of the Shifted Gompertz Distribution”. Communications in Statistics—Theory and Methods. 38 (1): 78-89; Torres, F. J. (2014).

Estimation of the Parameters of the Shifted Gompertz Distribution, Using Least Squares, Maximum Likelihood and Moments Methods Journal of Computational and Applied Mathematics. 255 (1): 867-877.

The SG can be parameterized in two different ways. Here it is using the parameters b and eta (η) which are explained below.

$$f ( t \vert η ) = {be}^{- bt} exp \{ - η {e}^{- bt} \} [ 1 + η ( 1 - {e}^{- bt} ) ] , t > 0$$

Here it is with the parameters p and q, which are explained below.

$$F ( t ) = ( 1 - {e}^{- ( p + q ) t} ) {( 1 + q / p )}^{- exp ( - ( p + q ) t )}$$

$$p > 0 , q \geq 0 , t > 0$$

Essentially, there are four parameters of interest in terms of description and relative dimensions of spread of new ideas and behaviors, and resistance in a population to new ideas or behaviors:

The parameters are p, q, b and eta (η).

These are determined by inputting time series data of events or items to programs which perform non-linear regression. As disclosed herein regarding the parameters, these can represent important sociological and behavioral measure such as the following:
b represents the appeal (the “pull”) of an idea or behavior to a population.
eta represents the resistance (the “pushback”) against an idea or behavior in a population.
p when small means there are few adopters and the idea or behavior is failing to get traction
q as it decreases the sigmoid SG equation becomes more like an exponential equation.

To measure changes in the appeal of an idea or behavior changes in resistance to an idea or behavior in a population, differences in Shifted Gompertz parameters (such as b and eta) from different locations or times can be compared. Additional mathematical properties of these parameters, and their combinations in various subequations have societal meaning.

### Applicability of Automated Gompertz Programs to General Crimes

The disclosure's facility in providing real-time automated Gompertz modeling of hate incidents, for description, analysis, and prediction has several important and non-obvious utilities. First, the Gompertz model itself provides a fit to the data which is highly optimized, and this conclusion is based on several mathematical and societal considerations. The use of this model in this disclosure can not only be used to hate, intimidation, and bias incidents (HIBI), but also many different types of typical crimes, including burglaries, assaults, etc.

To explain the link to many types of typical crimes, the mathematical properties of the Gompertz equation can be ascertained from its use in biology. For example:

(a) The Gompertz equation has been applied to describe the growth and spread of contagious diseases, such as Zika and Covid (Zhao, S., Musa, S. S., Fu, H., He, D., & Qin, J. (2019). Simple framework for real-time forecast in a data-limited situation: The Zika virus (ZIKV) outbreaks in Brazil from 2015 to 2016 as an example. Parasites & Vectors, 12 (1), 344. https://doi.org/10.1186/s13071-019-3602-9; Valle, J. A. M. (2020). Predicting the number of total COVID-19 cases and deaths in Brazil by the Gompertz model. Nonlinear Dynamics, 102 (4), 2951-2957. https://doi.org/10.1007/s11071-020-06056-w), as well as the growth of embryos, regenerative growth, and cancers.

(b) Allometry is a well-defined and studied mathematical power relationship between overall growth and its component parts, which is so prevalent in the biological world that some consider it a law of nature (West, G. B., & Brown, J. H. (2005). The origin of allometric scaling laws in biology from genomes to ecosystems: Towards a quantitative unifying theory of biological structure and organization. Journal of Experimental Biology, 208 (9), 1575-1592. https://doi.org/10.1242jeb.01589).

(c) Most growth phenomena follow a sigmoid (S-shaped) trajectory in time, i.e. the number of items or cases increases slowly initially, and then rapidly increases, and then tapers off.

(d) While linear trajectories require only two parameters in an equation to define them, sigmoid trajectories minimally require 3 parameters.

(e) There is a mathematical proof that if a biological system demonstrates allometry, then the Gompertz equation is the only 3 parameter equation that is consistent with the growth of that system (Deakin MA. 1970. Gompertz curves, allometry and embryogenesis. Bull Math Biophys. 1970 September; 32 (3): 445-52. doi: 10.1007/BF02476879)

(f) The Principle of Parsimony, otherwise known as Occam's razor, is a general guideline in all fields of science which is widely used for both practical and theoretical reasons. It is characterized by Gori as the following: “ . . . whenever we have different explanations of the observed data, the simplest one is preferable.” (Gori, M., Betti, A., & Melacci, S. (2023). Machine Learning: A constraint-based approach. chapter 2. Elsevier. (https://www sciencedirect.com/to s/computer-science/parsimony-principle).

Regarding the association of the above facts with crime data:

(g) Mohler (G. O. Mohler, M. B. Short, P. J. Brantingham, F. P. Schoenberg, and G. E. Tita, “Self-Exciting Point Process Modeling of Crime,” Journal of the American Statistical Association, Vol. 106, No. 493, 2011) indicated that crimes spread in the same pattern as contagious diseases. This fact has been validated by many studies (Perry, W., 2013). Predictive policing: The role of crime forecasting in law enforcement operations. Rand Corporation, p. 42).

(h) The inventor, as far as has been found, is the first to apply the Gompertz equation to any sort of crime, and has demonstrated its applicability and excellent goodness-of-fit to hate crimes.

(i) Many types of crimes have been demonstrated to be consistent with the allometry equation (e.g. Alves, L. G. A., Ribeiro, H. V., Lenzi, E. K., & Mendes, R. S. (2014). Empirical analysis on the connection between power-law distributions and allometries for urban indicators. Physica A: Statistical Mechanics and Its Applications, 409, 175-182. https://doi.org/10.1016/.physa.2014.04.046; Caminha, C., Furtado, V., Pequeno, T. H. C., Ponte, C., Melo, H. P. M., Oliveira, E. A., & Andrade, J. S. (2017). Human mobility in large cities as a proxy for crime. PLOS ONE, 12 (2), e0171609. https://doi.org/10.1371/joumal.pone.0171609).

The inventor has found that for all crimes demonstrated to be consistent with the allometry equation, and whose cumulative growth follows a s-shaped pattern, the Gompertz curve isn't merely one of a variety of equations which can fit the data, but is, in fact, the optimal mathematical model, considering Deakin's assertion regarding 3 parameter curves, and the Principle of Parsimony. So, for instance, if other models such as multifactor stepwise regression, or big data mining or machine learning or artificial intelligence were to come up with equally good fits to the data, the Principle of Parsimony teaches that the simplest model, which in this case is the Gompertz, equation, is preferable. Thus, these other models would be likely superfluous, and based on experience in the field of biology (which of course includes humans and their behavior), they would lead to unnecessarily complex explanations of the phenomena, which explanations would prove to be either erroneous, misleading or confusing.

In sum, for many categories of crimes, the Gompertz equation can be the optimal mathematical model in some implementations. Additionally, the automation of this model by the inventor, provides the real-time information for policing needed for quick analysis and response to hate, intimidation and bias incidents (HIBI, as well as many categories of crime. In 1970, it took about 24 hours to perform a single regression by computer. Performing a single regression, with associated outputs such as confidence intervals and graphs, of a current computer, can be done in minutes. The automated program can run numerous regressions even more quickly and on many different locations.

As an example, it extends the utility of “Hot-Spot” policing model of Radcliff, 2004, The HotSpot model is currently used in some police precincts. Of the three temporal categories Radcliff describes, it is likely that the Gompertz equation would fit at least two of them, giving local police good forecasting capabilities of the course and dimensions of incipient crime waves.

In summary, for certain large categories of general crime, where they are found to have both allometric and sigmoid properties, the automated Gompertz program herein described, provides the optimal practical real-time model, making possible good specific predictions such that intervention by law enforcement will now be more timely and more practical.

### Automation of Regression Analysis

Running a statistical program such as JMP for the purpose of modelling a data set is generally a somewhat tedious and time-consuming process where an operator must sit with the keyboard and mouse and for each individual step pull down a menu or move a mouse or click a mouse button or enter he keystrokes or text. Some of actions typically requiring operator intervention include: import the dataset from excel, chose the nonlinear platform, identify which data columns represent x and y variables, run the nonlinear platform, select the Gompertz equation, save the output in JMP, PDF, and text forms, save the predicted data points, save the first derivatives, plot the first derivatives, etc.

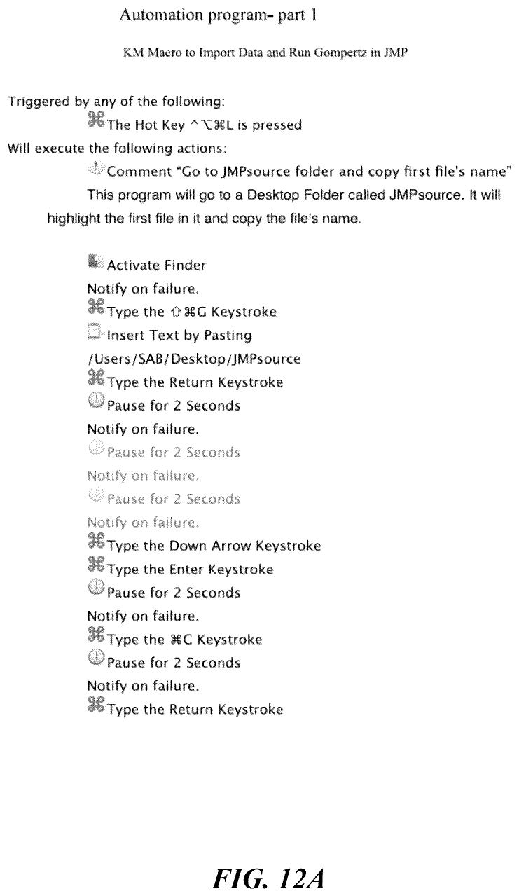

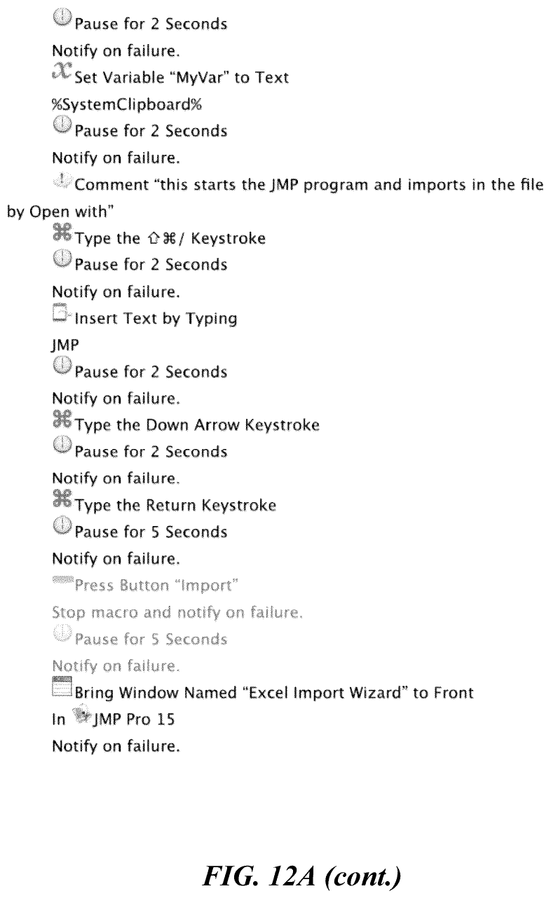

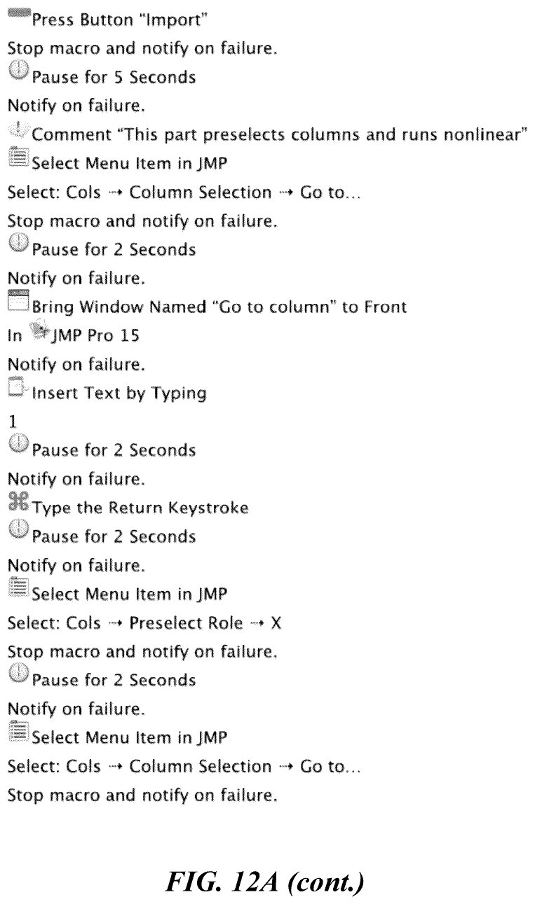

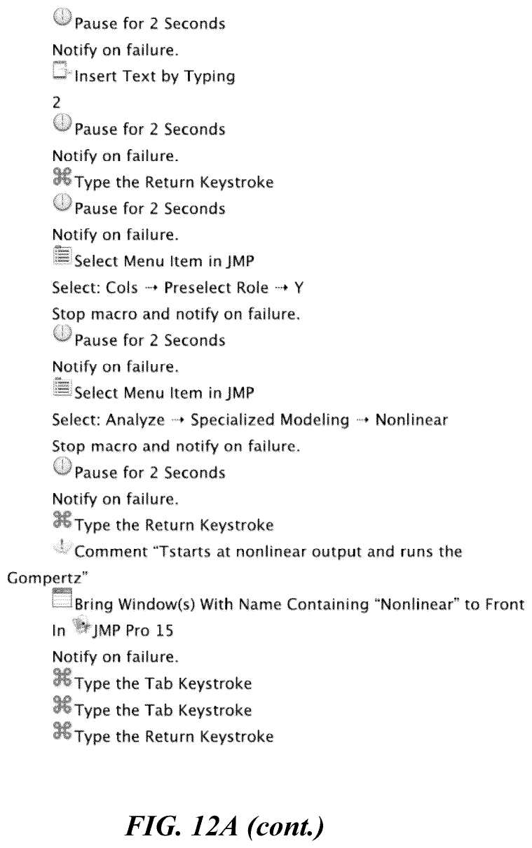

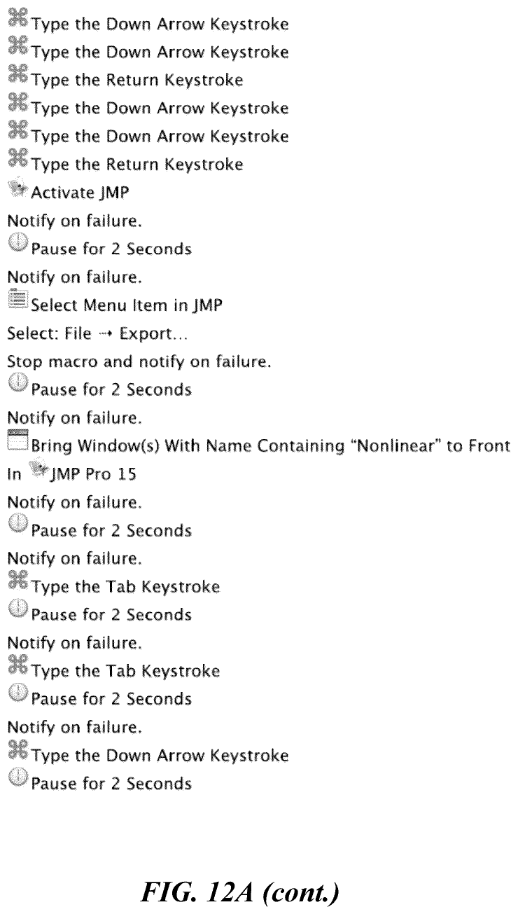

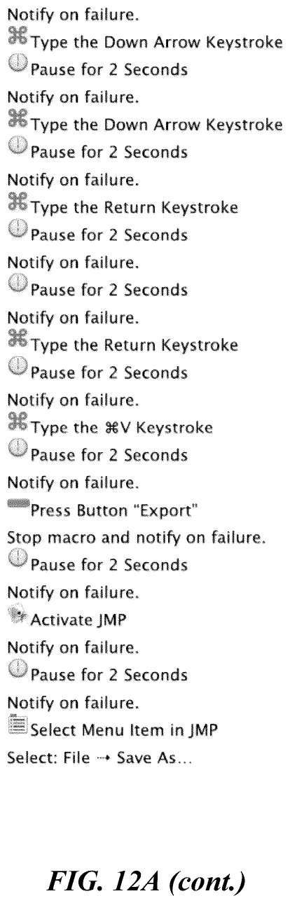

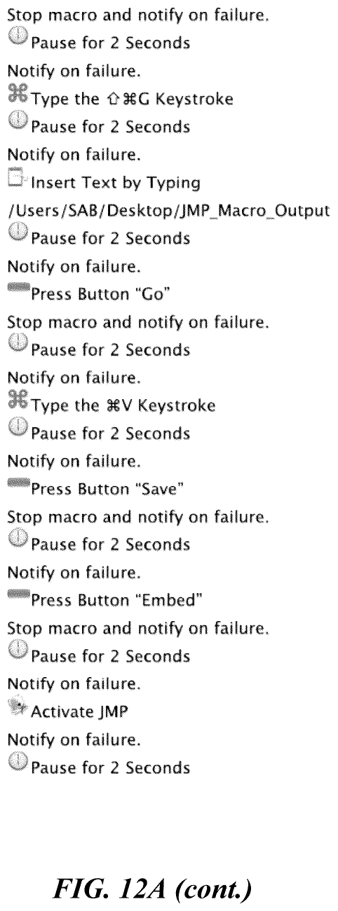

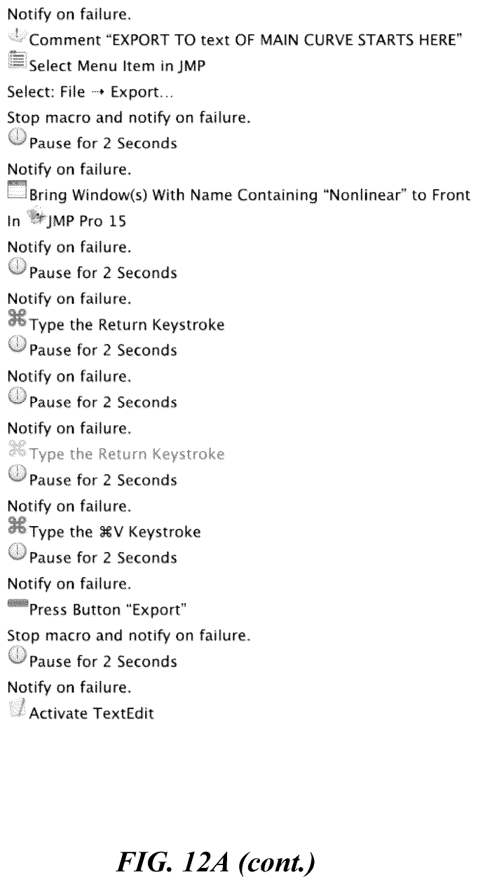

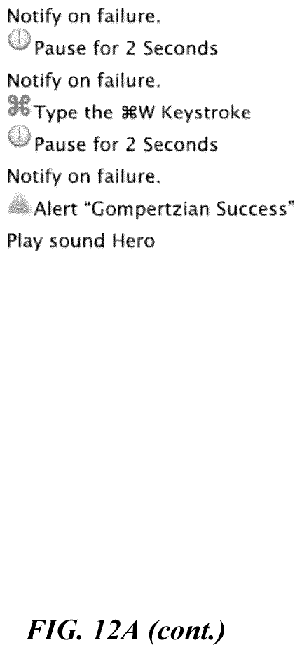

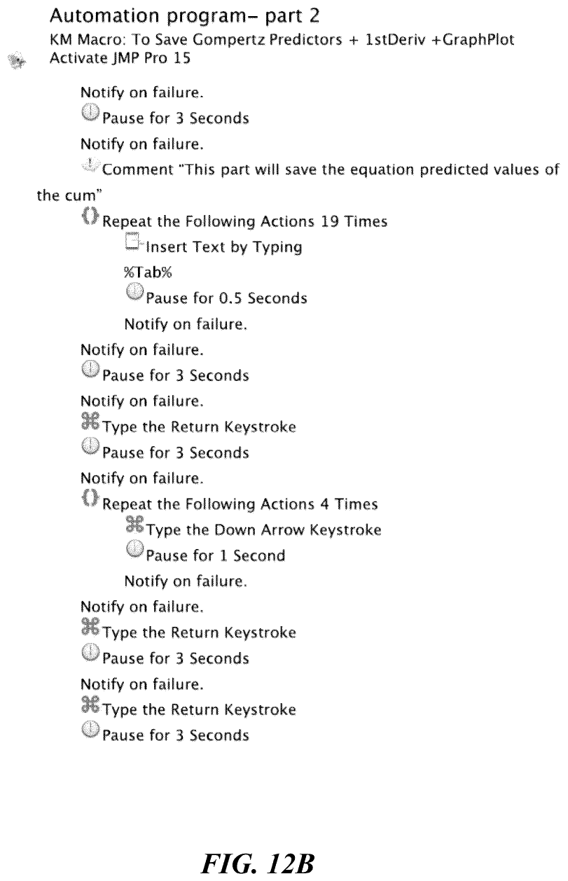

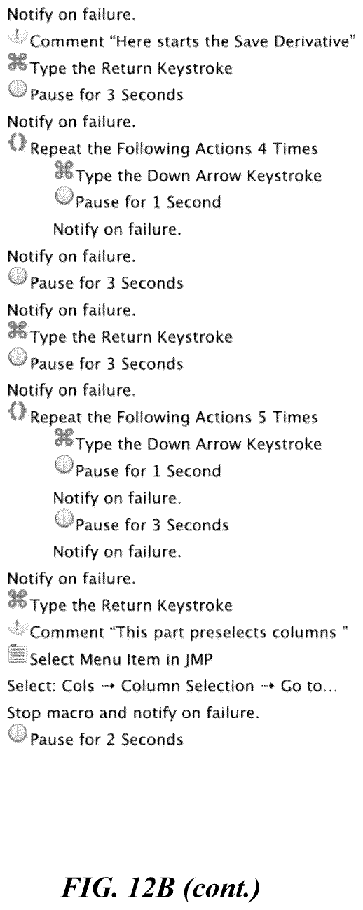

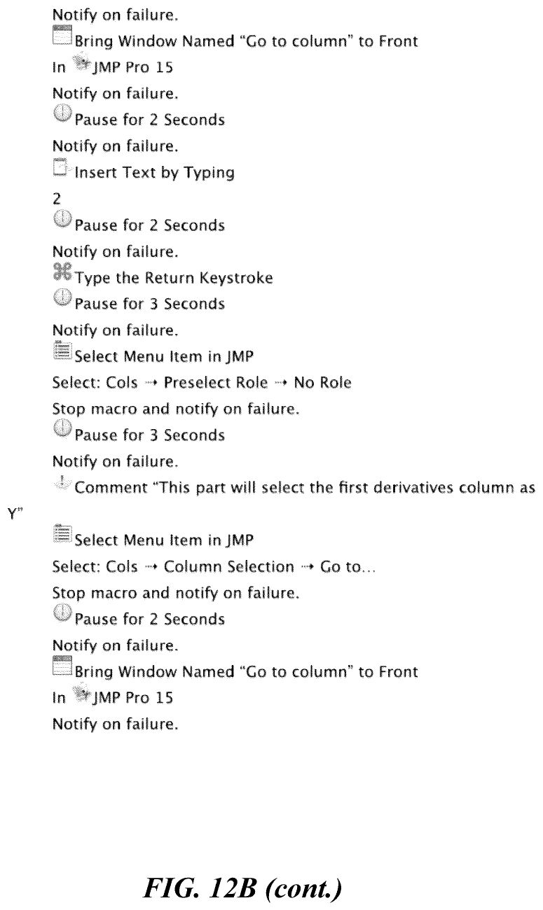

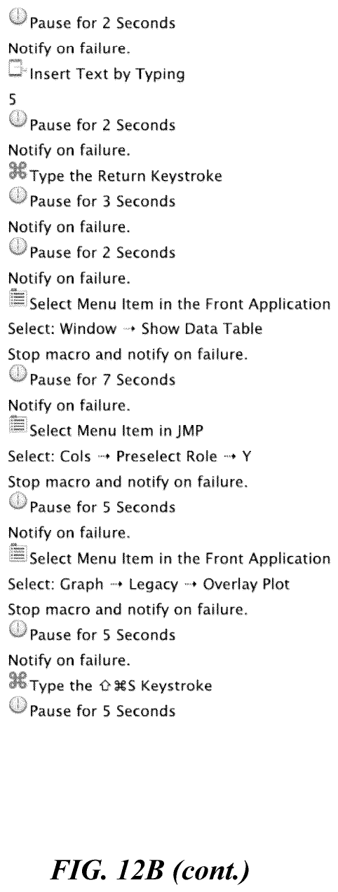

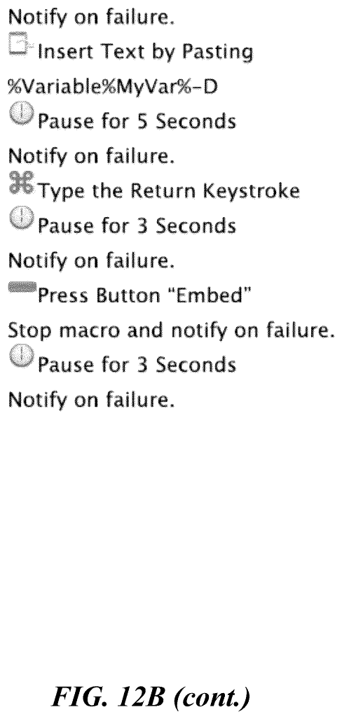

The inventor has written custom programs, using an application known as Keyboard Maestro for the Macintosh computers, where for the Gompertz program, almost all such steps are implemented by the Keyboard Maestro program once it is started, without further operator intervention or action, see FIG. 12.

For the Shifted Gompertz program, the inventor has implemented it in JMP, and written an automation program similar to the one just described.

### Decision Analysis (HIBI-DECIDE Module)

This disclosure provides for the use of Ranking Systems and Mathematical Modeling to provide inputs for Decision Analysis model support for real-world decisions. Mathematical modeling using Decision Analysis systems involves using mathematical techniques and tools to support decision-making processes. Decision Analysis systems typically incorporate various mathematical models and algorithms to analyze data, assess uncertainties, and optimize decision outcomes. Mathematical modeling using Decision Analysis systems provides a systematic and quantitative approach to decision-making, enabling stakeholders to make informed choices, evaluate trade-offs, and assess the potential impact of different decisions. It helps mitigate risks, optimize resources, and improve the overall quality of decision-making processes.

This disclosure provides for the use and applicability of Decision Analysis to hate, discrimination and bias. The HIBI-DECIDE module can provide assistance in deciding whether action should be taken to prevent or mitigate a HIBI incident. The HIBI-DECIDE module can, in some implementations, fundamentally require at least three inputs:
1. Statement of the decision to be made.
2. A “utility” to be assigned to each alternative branch in the decision. The “utility” can be thought of as a relative value or payback for accepting that alternative branch in the decision.
3. A “probability” assigned to each alternative branch.

The estimates of the probabilities can be arrived at by mathematical models, expert consensus, or other methods, as described further below. In some implementations, the HIBI-DECIDE module can output measures called Decision Utilities, from which a user (or the module itself) can select the course of action (or inaction) with the highest Decision Utility. Often, when actions are taken to prevent or mitigate an incident, the probability of the incident is less. For example, in an authoritarian country, if the government declares that anyone who participates in a particular protest demonstration will be arrested, it is likely that the probability that the protest will occur will be diminished. However, there can be some situations where the probability of an incident occurring is not affected by whether or not action to prevent or mitigate is taken.

The disclosure herein provides a method wherein the ranking systems can provide the utilities and the mathematical modeling (e.g., of sigmoid curves) can provide the probabilities. For example, for an incident described using the ranking system, the HIBI-DECIDE module can generate a Decision Utility.

Utilities from Ranks

Utilities for the purpose of Decision Analysis (also called Decision Theory) can be derived in a number of ways, including, for example, expert interviews and focus groups. Several sophisticated methods for using ranks to make decisions are reviewed and cited by Xia, Lirong, 2022. Learning and Decision-Making from Rank Data. Springer Nature Switzerland AG.

Here are some examples of simple scoring systems that can be used to derive utilities from ranks.

(a) Example using binary valued ranks-If there are overall thirty ranks and all are assigned a weight of 1 if there has been any incident(s) or 0 if there have been no incident(s), then the maximum possible score would be attained if 1 is assigned to each of the thirty ranks, and then each rank is multiplied by its weight and summed. This would represent maximum of utility (in the negative sense, e.g. worse case). Then, for a given location in a given time period, the actual reported events are scored and the score is reported as a percentage of the maximum utility as described above. These could then be normalized by the population of the location, or by thousand, etc.

(b) Example using frequency-A focus group of experts would convene and reach consensus on sample maximum frequencies and apply as above with the number of occurrences replacing the number 1 above. Percent of maximum score would be calculated, so if the population of country is n and all scores from top down are positive and in proportion to weight of that category and an assigned maximum frequency. This could also be normalized by per 1000; 10,000; 100,000; or million.

Probabilities from Sigmoid Equations Such as Gompertz and Shifted Gompertz

To get probabilities for the Decision analysis, regression analysis of events or behaviors is performed. Confidence intervals (e.g. 95% confidence interval) are used to estimate possibilities of outcomes. These are then used in the computations of Decision Analysis.

### Classification System

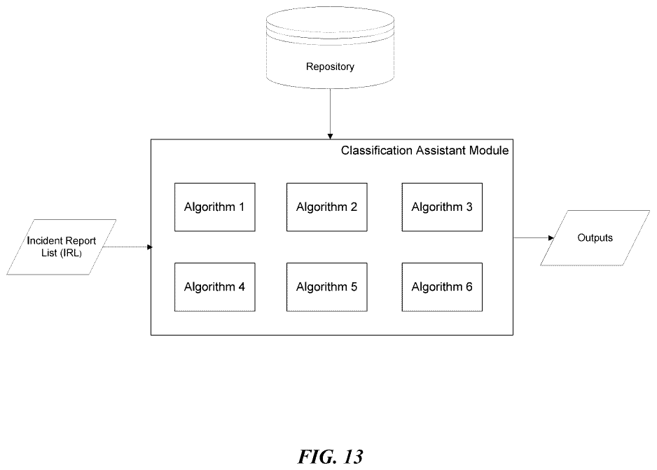

FIG. 13 is block diagram showing an exemplary classification assistant (CA) module for a Hate, Intimidation, and Bias Incident (HIBI) analysis system (referred to interchangeably herein as a “HIBI-CA” module). As noted above, the HIBI-CA module described herein provides a real-time, at least semi-automated tool for scoring and ranking hate, intimidation, and bias incidents that expedites objective evaluation of such incidents. The HIBI-CA module can provide a series of algorithms, which can be used individually, sequentially, or in any combination, to rank and/or assess incidents. The HIBI-CA module, for at least some of the algorithms, can rely on a Repository, that can be frequently updated, including the following components (a) sentences previously classified, (b) phrases previously classified, and/or (c) keywords previously classified.

Although the algorithms can be used individually or in any combination, here they are presented in a representative order that is merely for exemplary purposes. The list of incidents to be classified is referred to herein as the Incident Report List (IRL). In summary, Algorithm 1 can search the IRL for sentences previously classified in the Repository, and if a sentence is found, its rank is entered. Algorithm 2 can search the IRL for phrases or keywords previously classified in the Repository. Algorithm 3 can remove duplicates to facilitate ranking. Algorithm 4 can search, ad hoc, keywords and phrases that are not in the Repository, and can highlight them to assist in ranking. Algorithm 5 can construct a word frequency table from the remainder of the text in the IRL, which can assist in identifying the focus of a body of reports. Algorithm 6 can identify nouns and verbs. The nouns and verbs can then be manually reviewed, as they often have the greatest information content. The remainder of the text in the IRL can then be manually reviewed for ranking. In summary, the HIBI-CA module can provide at least semi-automated algorithms which can assist in ranking and scoring for previously identified types of incidents, characterized by sentences, phrases, or keywords, with accessory search and sorting methods to speed up, for real-time or near real-time use, classification of hate, intimidation, and bias incidents. Further details regarding Algorithms 1-6 will now be discussed in detail.

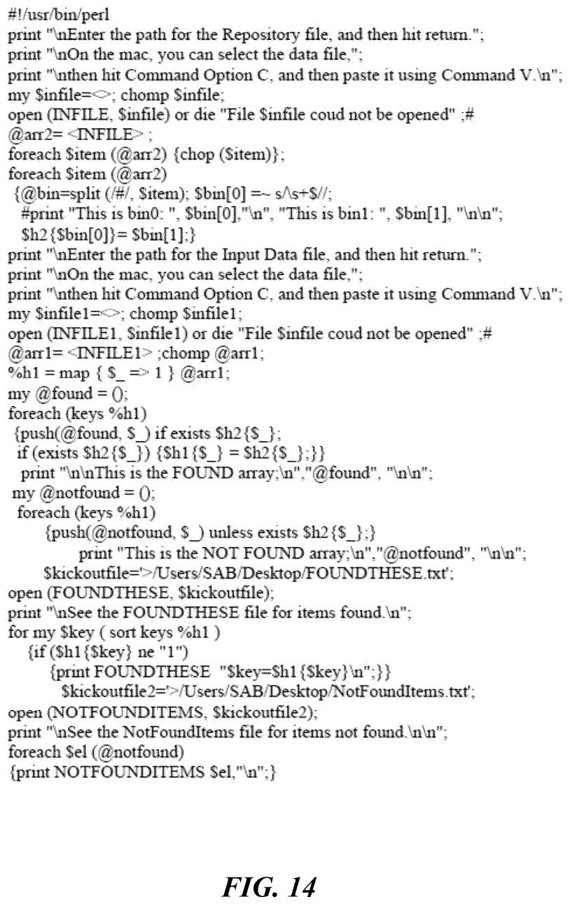

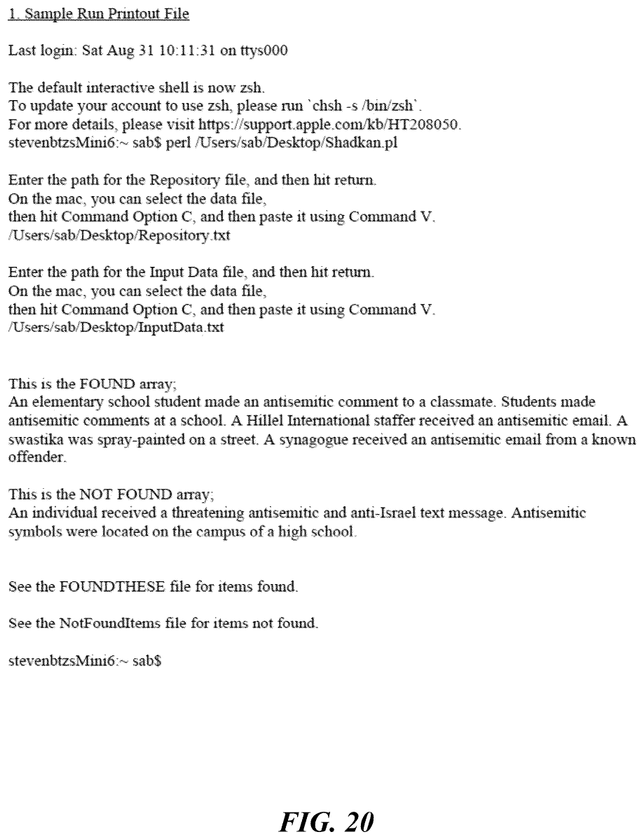

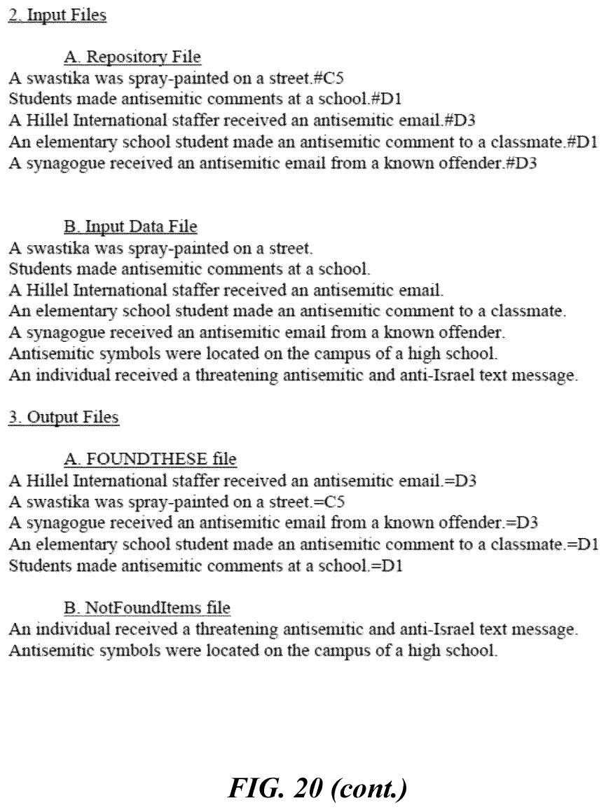

Algorithm 1 can identify sentences (about hate, intimidation, or bias incidents), which have previously been ranked, and are present in the Repository, which can be a library file. The Incident Report File referred to above is called an Input Data file by the program. The user can be asked to paste in the Repository File and the Input Data file. The algorithm can then produce two files: a FOUNDTHESE file which contains the sentences that have been ranked and are in the Repository, and a NotFoundItems file which contains the sentences that have not been found. FIG. 14 illustrates an exemplary Algorithm 1 of a HIBI-CA module. FIG. 20 illustrates a sample run of Algorithm 1 of a HIBI-CA module.

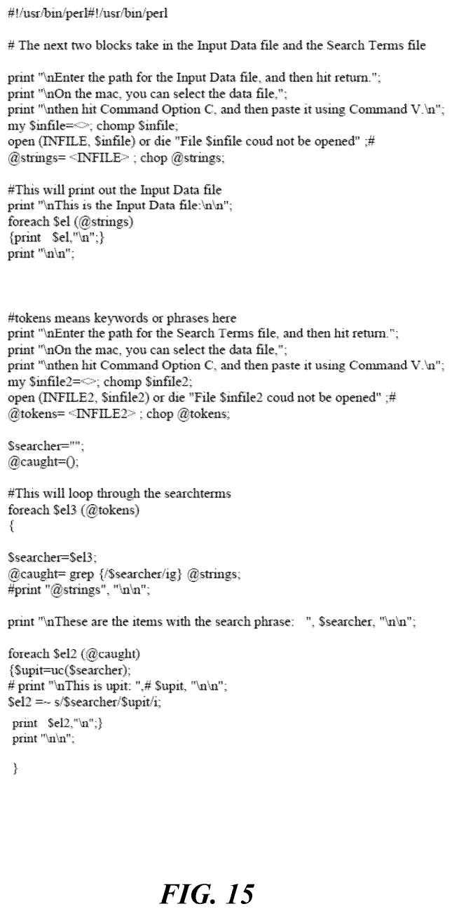

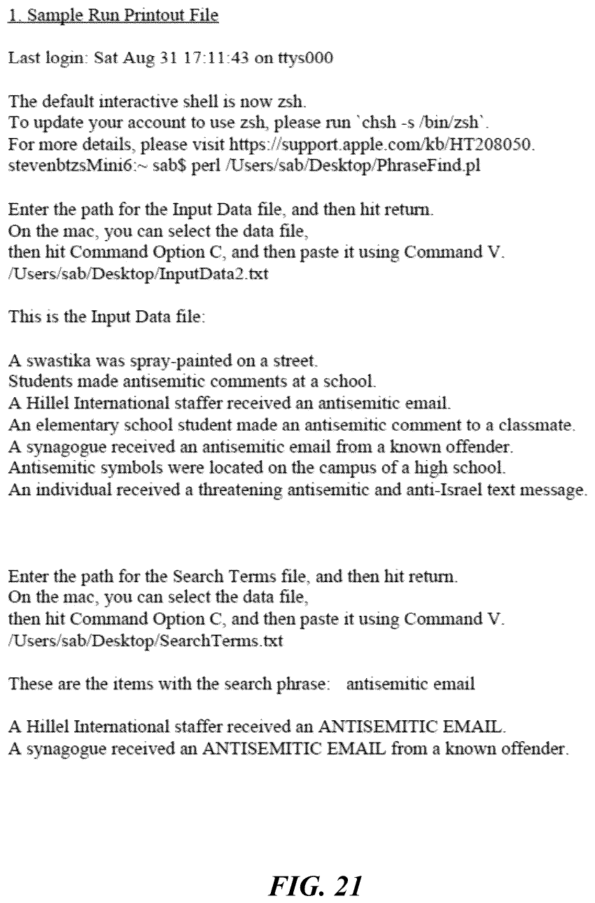

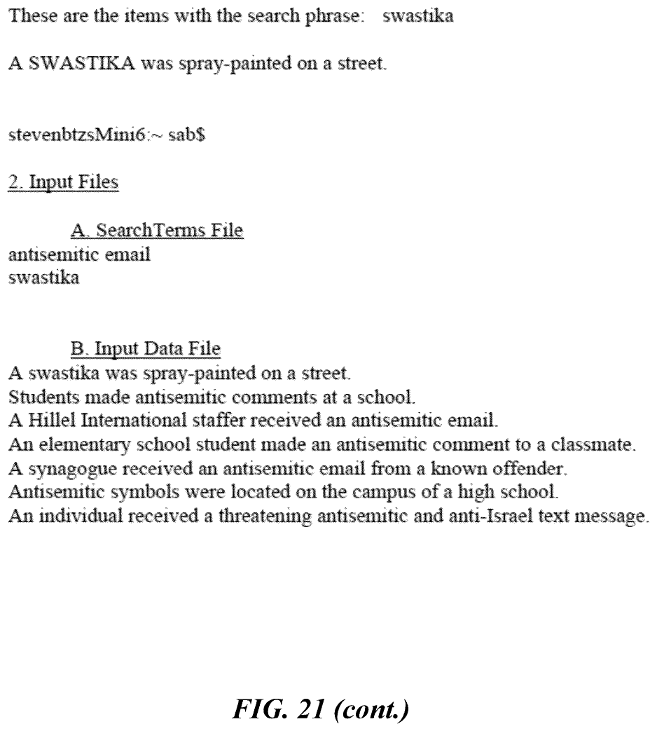

Algorithm 2 can identify phrases or words from a repository of relevant terms. The Incident Report File referred to above is called an Input Data file by the program. The user is asked to paste in the path to the Input Data file, and to the SearchTerms file from the Repository. The algorithm then produces output in the terminal, where each search term is CAPITALIZED for clarity in the sentences in which it appears. FIG. 15 illustrates an exemplary Algorithm 2 of a HIBI-CA module. FIG. 21 illustrates a sample run of Algorithm 2 of a HIBI-CA module.

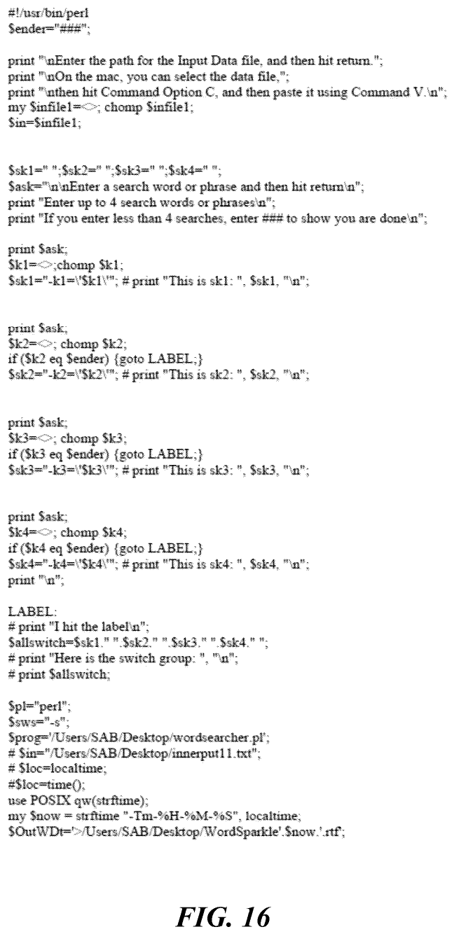

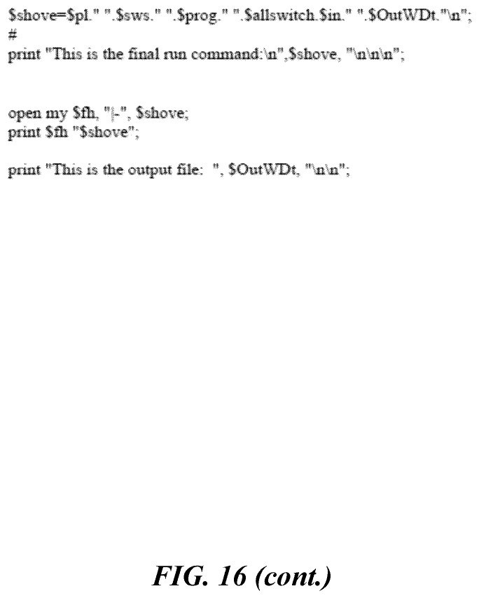

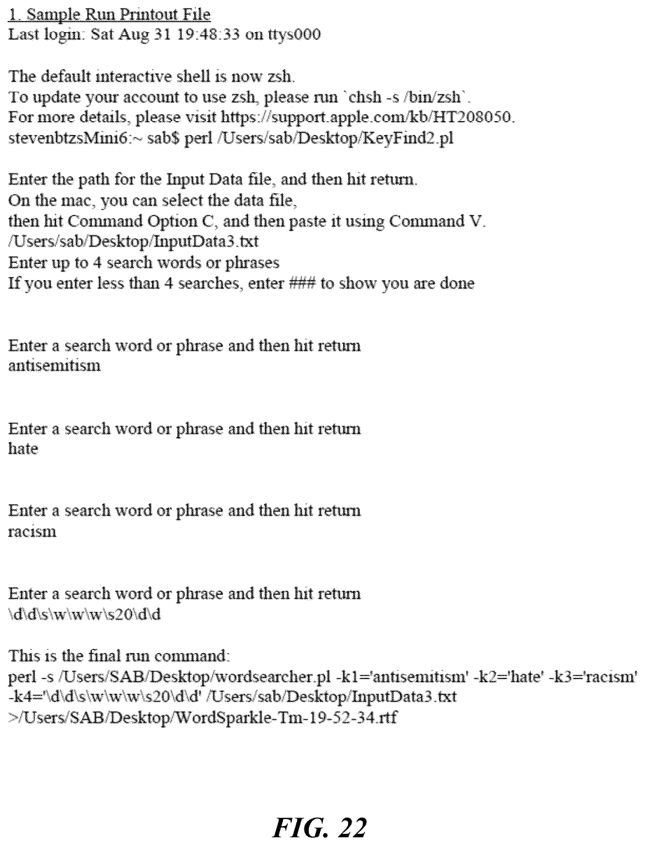

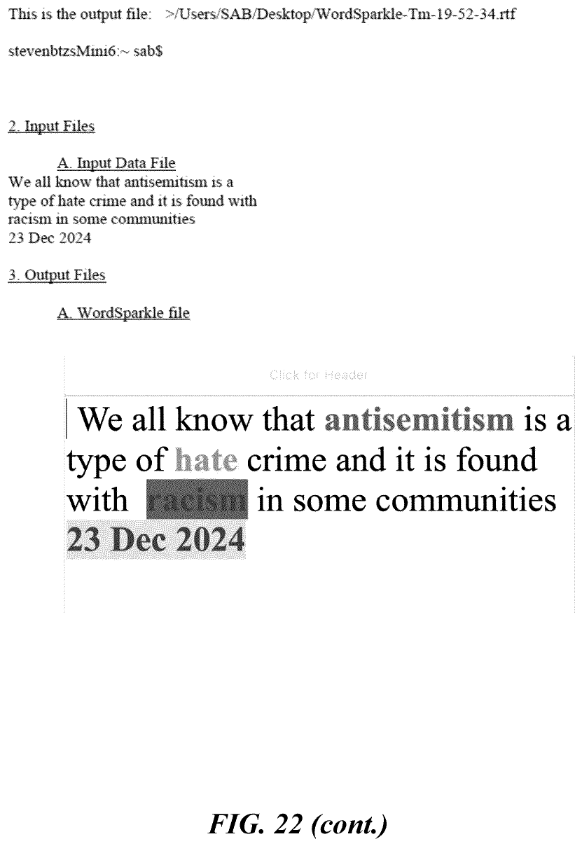

Algorithm 3 can provide an ad hoc method to search for words or phrases which are not in the Repository and/or are new. The user can be requested to paste in the path to the Input Data file. Then, the user can be interactively asked to enter up to four phrases or words. Algorithm 3 can then reproduce the Input Data text where each search term is highlighted for clarity in a different color. As the sample run below demonstrates, in its search of a date, Algorithm 3 can provide a feature for advanced fine-tuned searches for patterns, which in Perl is called regular expressions. FIG. 16 illustrates an exemplary Algorithm 3 of a HIBI-CA module. FIG. 22 illustrates a sample run of Algorithm 3 of a HIBI-CA module.

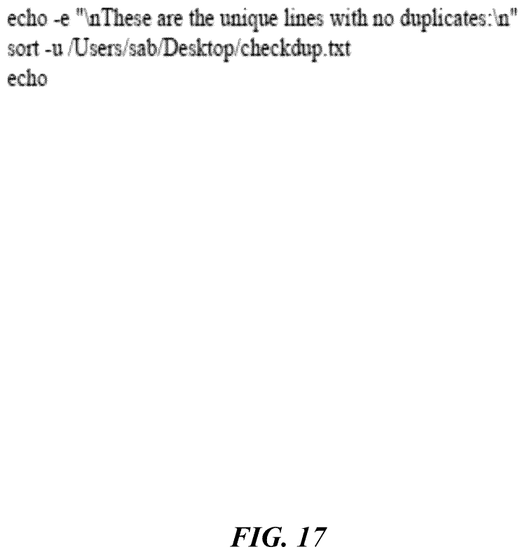

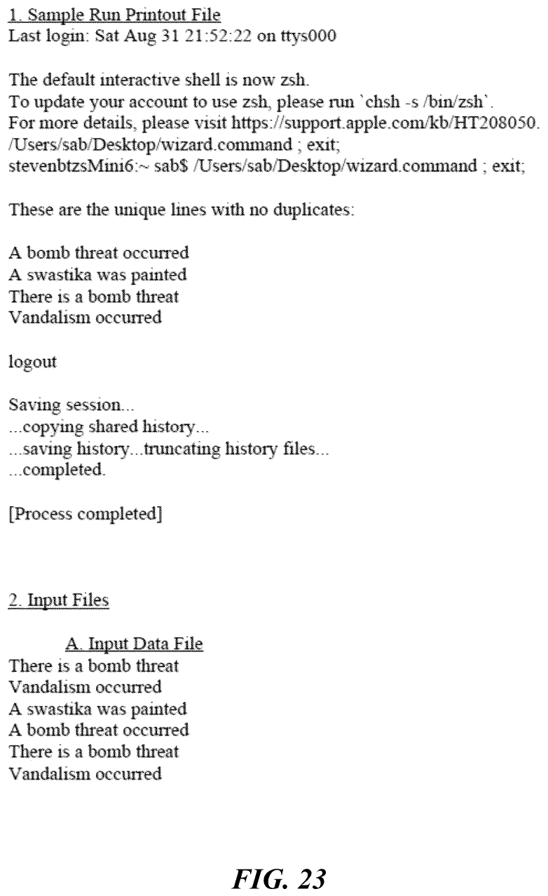

For the purposes of classification and ranking, Algorithm 4 can eliminate duplicates from a file. The user can create a text file of the Incident Report List called checkdup.txt on the Desktop. The user can copy the wizard.command file to the Desktop. The user can then open the command line interface (Terminal on Mac) and type the following: chmod a+x wizard.command. The user can then double click the icon of the wizard.command program. In the Terminal, Algorithm 4 can produce a list of the unique lines, which the user can copy to a new Incident Report List file. FIG. 17 illustrates an exemplary Algorithm 4 of a HIBI-CA module. FIG. 23 illustrates a sample run of Algorithm 4 of a HIBI-CA module.

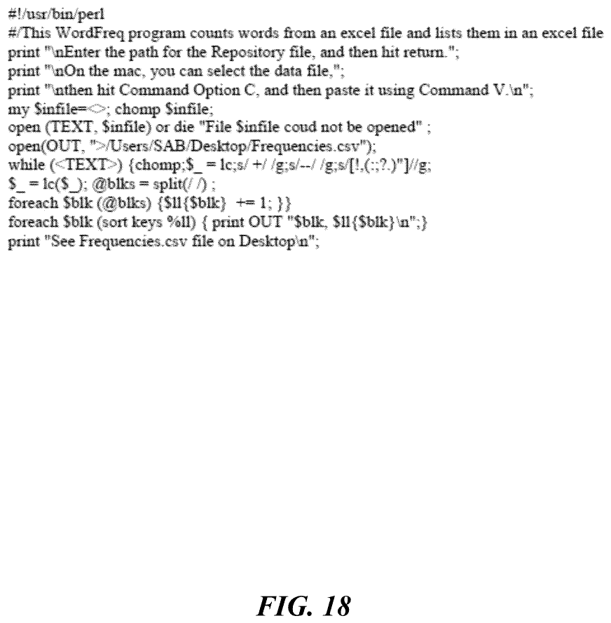

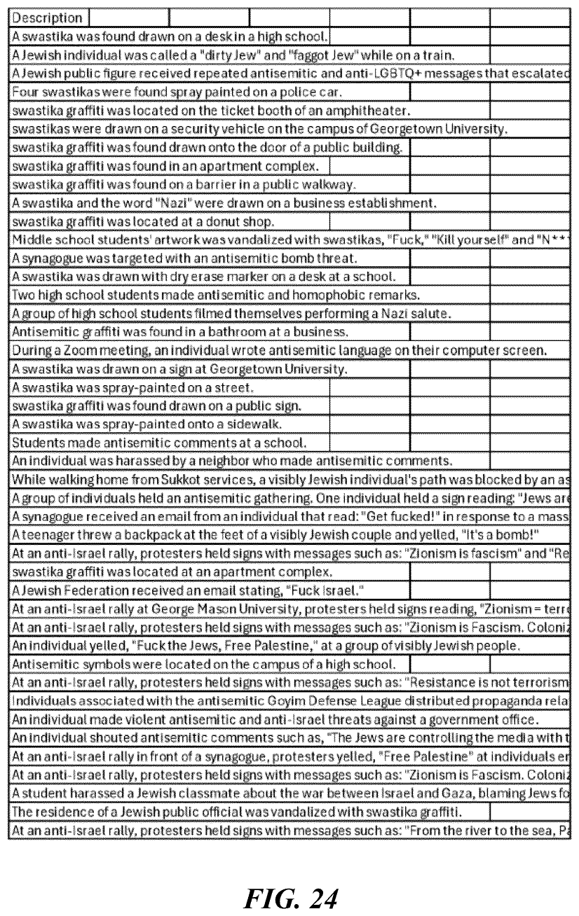

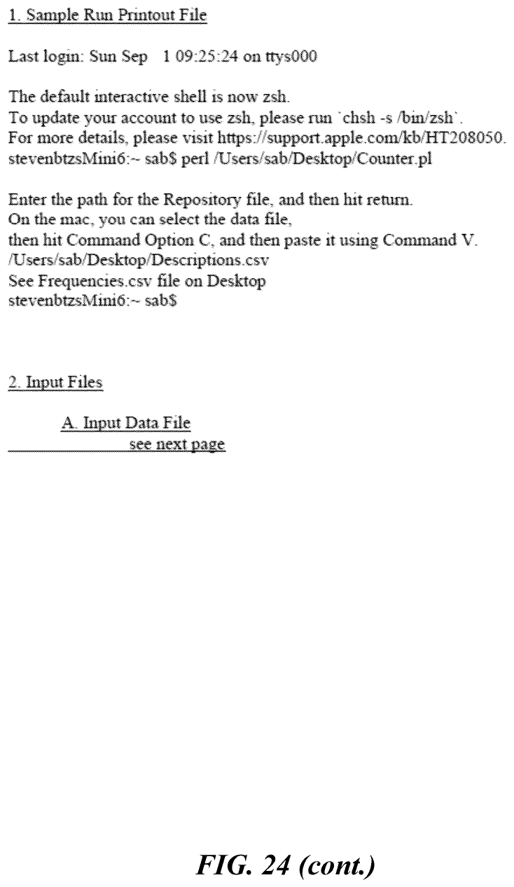

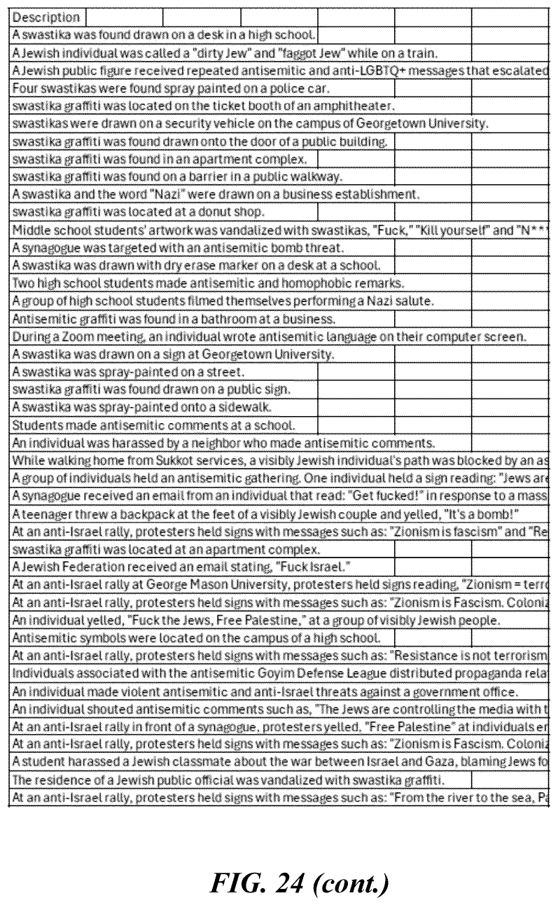

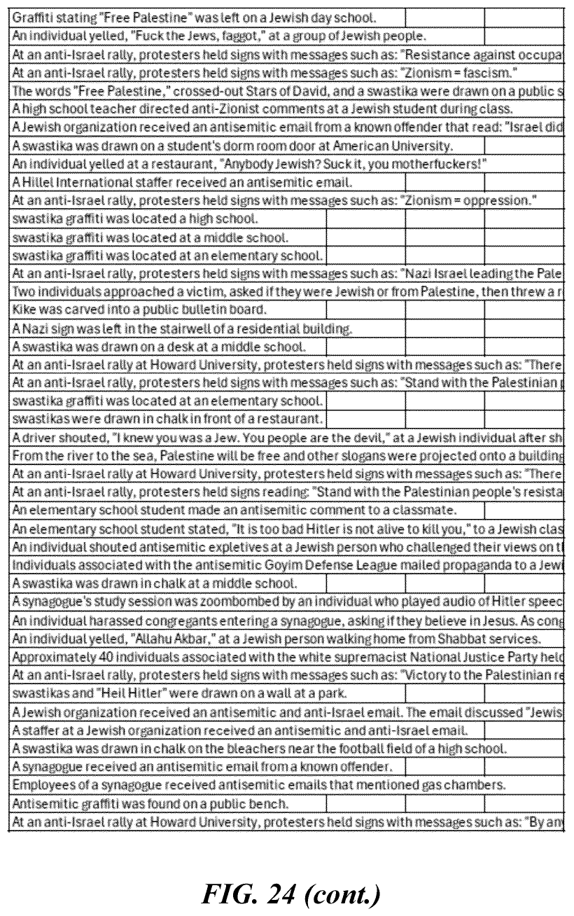

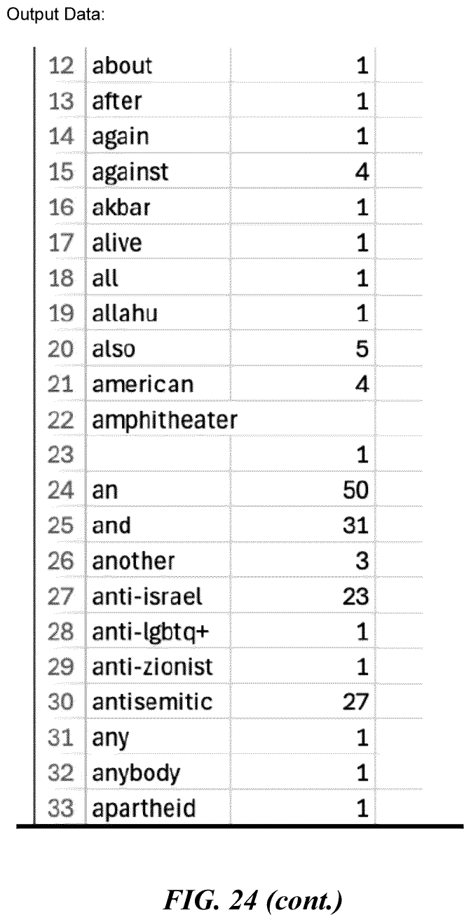

Often it is useful to identify the frequencies of words in a list or dataset, as this may give an indication of the focus of the material. Algorithm 5 can take in a list as an Excel datasheet, and produce a frequency count for each word. FIG. 18 illustrates an exemplary Algorithm 5 of a HIBI-CA module. FIG. 18 illustrates an exemplary Algorithm 5 of a HIBI-CA module. FIG. 24 illustrates a sample run of Algorithm 5 of a HIBI-CA module.

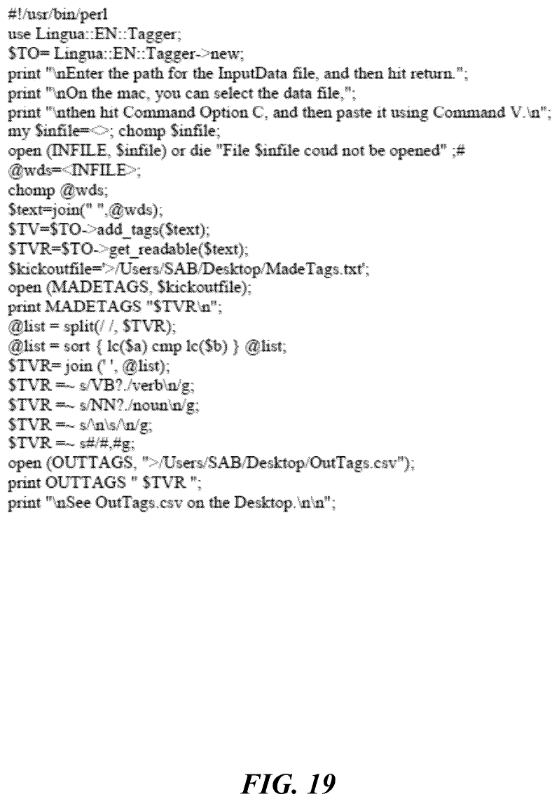

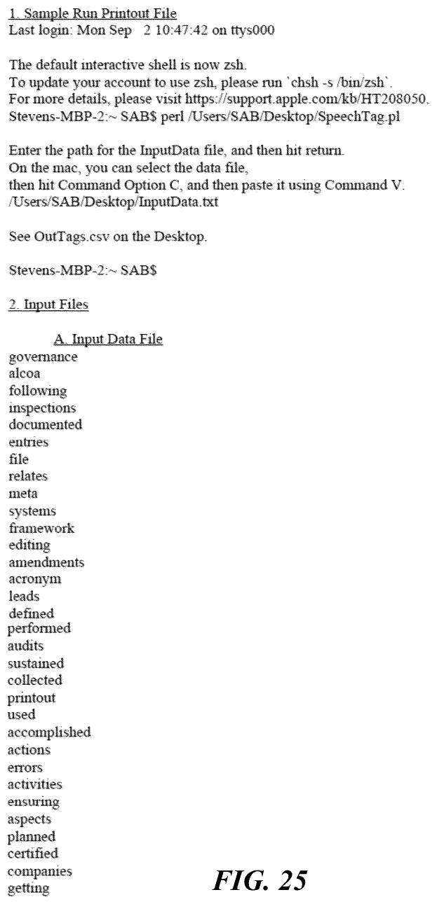

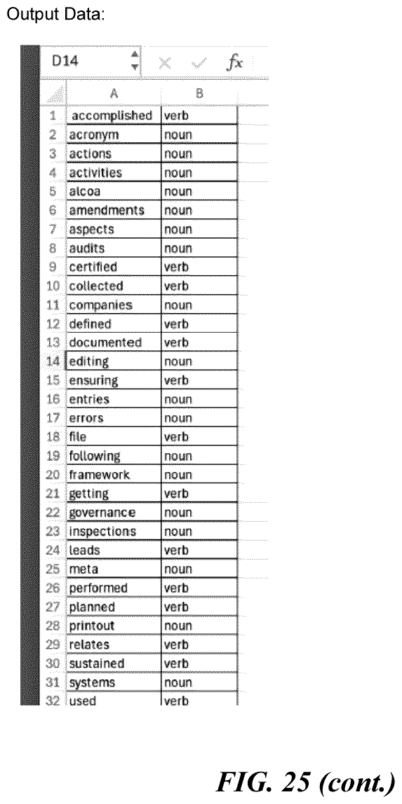

In identifying terms in reports, it is often useful to know their parts of speech, such as nouns or verbs. For instance, vandalism and assault are nouns found in a text that can immediately lead to classification. Algorithm 6 can ask the user to paste in the path to a file with a list of words, and produce an Excel-compatible list where nouns and verbs are identified. They can be further sorted or filtered in Excel. FIG. 19 illustrates an exemplary Algorithm 6 of a HIBI-CA module. FIG. 19 illustrates an exemplary Algorithm 6 of a HIBI-CA module. Lingua::Tagger is a Perl module available on CPAN (Comprehensive Perl Archive Network) used for linguistic analysis, specifically for tagging words in a piece of text with their corresponding parts of speech (POS) or other linguistic attributes. The primary purpose of Lingua::Tagger is to mark words in text with tags indicating their part of speech, such as nouns, verbs, adjectives, etc. It can break the input text into tokens, which are generally words or punctuation marks. It provides some fundamental linguistic processing tools, like handling contractions or recognizing some common grammatical patterns. Although its name suggests it is for linguistic processing, the extent of multilingual support depends on the specific taggers and dictionaries available for the language being processed. This module can be useful for developers building tools for natural language processing (NLP), such as sentiment analysis or keyword extraction and can be used to gain insights into sentence structures or analyze the linguistic components of texts. FIG. 25 illustrates a sample run of Algorithm 6 of a HIBI-CA module.

As shown and described, the HIBI-CA module can retrieve data from multiple disparate sources, combine them in an unconventional and nonobvious way, and make a number of various outputs having practical applications in the field of incident classification. For example, the HIBI-CA module can at least semi-automate the process of classifying incidents by analyzing semantics and matching such semantics to incidents that have been previously classified within a library in real-time or near real-time. Such semantics can include identical or similar sentences, phrases, keywords, etc.

### Person or Group

As disclosed herein, the system and method for description, analysis, tracking, classification, prediction, and assessment of incidents and speech related to hate, intimidation, and bias against a person who is subject to bias, and/or a group whose members are subject to bias, wherein the bias may be based upon, for example, age, race, ethnicity, religion, gender, sexual orientation, disability, socio-economic status or familial socio-economic status, citizenship status, association with institutions such as schools, charities, political organization, etc. The disclosure provides for methods to support decisions related to intervention, mitigation, and defense against such biased activities and speech.

### Computing Device

A computing device may be used to implement various aspects as described herein. More particularly, in some embodiments, aspects of the method for quantitatively describing and predicting trends and specific numbers of incidents and activities may be translated to software or machine-level code, which may be installed to and/or executed by the computing device such that the computing device is configured to learn rules and formulate predictions associated with cyber threats as described herein. It is contemplated that the computing device may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device may include various hardware components, such as a processor, a main memory (e.g., a system memory), and a system bus that couples various components of the computing device to the processor. The system bus may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device may further include a variety of memory devices and computer-readable media that includes removable/non-removable media and volatile/nonvolatile media and/or tangible media but excludes transitory propagated signals. Computer-readable media may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the general purpose computing device. Communication media includes computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory includes computer storage media in the form of volatile/nonvolatile memory such as read only memory (ROM) and random-access memory (RAM). A basic input/output system (BIOS), containing the basic routines that help to transfer information between elements within the general-purpose computing device (e.g., during start-up) is typically stored in ROM. RAM typically contains data and/or program modules that are immediately accessible to and/or presently being operated on by processor. Further, a data storage stores an operating system, application programs, and other program modules and program data.

The data storage may also include other removable/non-removable, volatile/nonvolatile computer storage media. For example, data storage may be: a hard disk drive that reads from or writes to non-removable, nonvolatile magnetic media; a magnetic disk drive that reads from or writes to a removable, nonvolatile magnetic disk; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules and other data for the general-purpose computing device.

A user may enter commands and information through a user interface (displayed via a monitor) by engaging input devices such as a tablet, electronic digitizer, a microphone, keyboard, and/or pointing device, commonly referred to as mouse, trackball or touch pad. Other input devices may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices are in operative connection to the processor and may be coupled to the system bus, but may be connected by other interface and bus structures, such as a parallel port, game port or a universal serial bus (USB). A monitor or other type of display device may also be connected to the system bus. The monitor may also be integrated with a touch-screen panel or the like.

The computing device may be implemented in a networked or cloud-computing environment using logical connections of a network interface to one or more remote devices, such as a remote computer. The remote computer may be a personal computer, a server, a router, a network PC, a peer device or other common network node, and typically includes many or all of the elements described above relative to the general-purpose computing device. The logical connection may include one or more local area networks (LAN) and one or more wide area networks (WAN) but may also include other networks. Such networking environments are commonplace in offices, enterprise-wide computer networks, intranets and the Internet. When used in a networked or cloud-computing environment, the computing device may be connected to a public and/or private network through the network interface. In such embodiments, a modem or other means for establishing communications over the network is connected to the system bus via the network interface or other appropriate mechanism. A wireless networking component including an interface and antenna may be coupled through a suitable device such as an access point or peer computer to a network. In a networked environment, program modules depicted relative to the general-purpose computing device, or portions thereof, may be stored in the remote memory storage device.

Certain embodiments are described herein as including one or more modules. Such modules can be a hardware implemented module, a software implemented module, or a combination thereof, and thus may include at least one tangible unit capable of performing certain operations and may be configured or arranged in a certain manner.

Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., at least one processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

The invention will be illustrated in more detail with reference to the following Examples, but it should be understood that the present invention is not deemed to be limited thereto.

### EXAMPLES

Example 1—Descriptive and predictive mathematical modeling of Anti-Defamation League ten-year antisemitism data using the Gompertz equation for cumulated yearly counts.

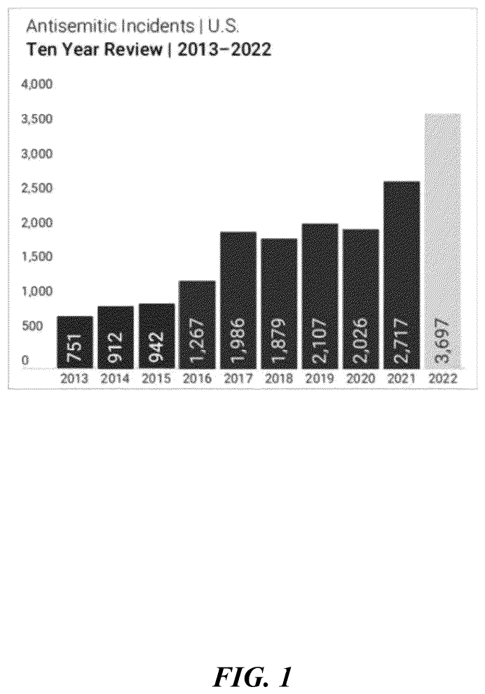

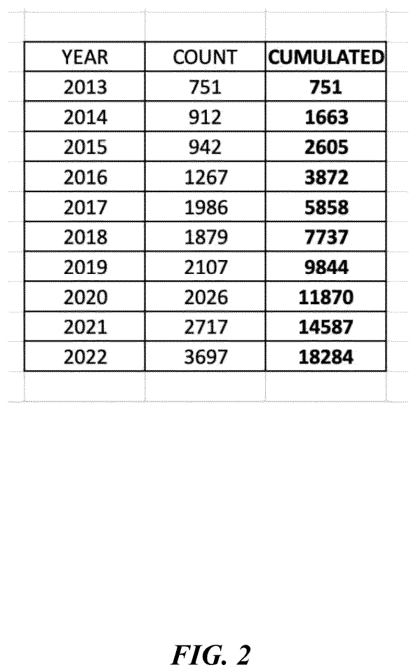

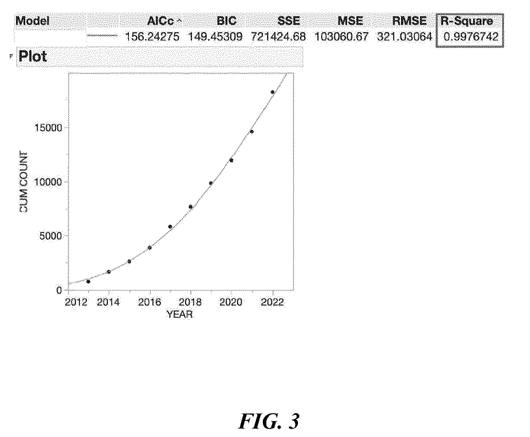

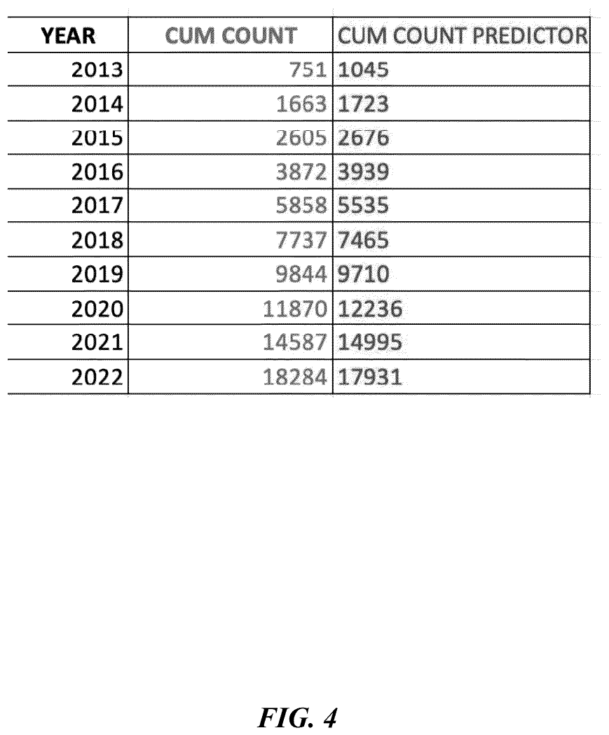

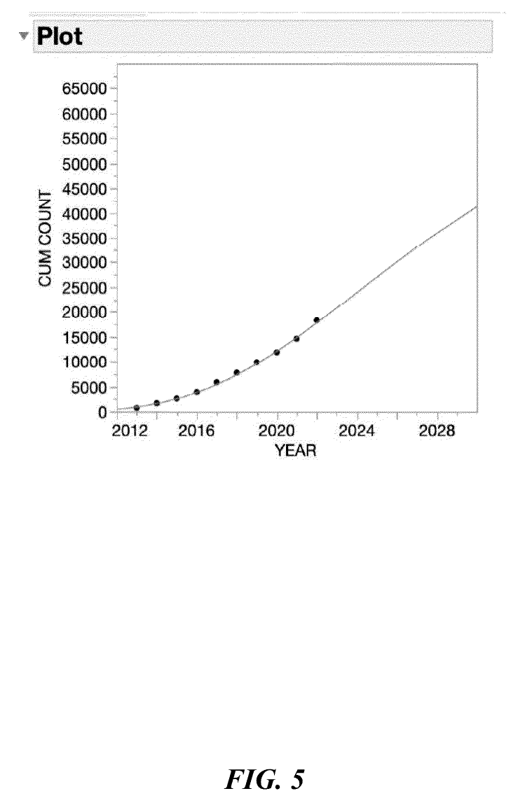

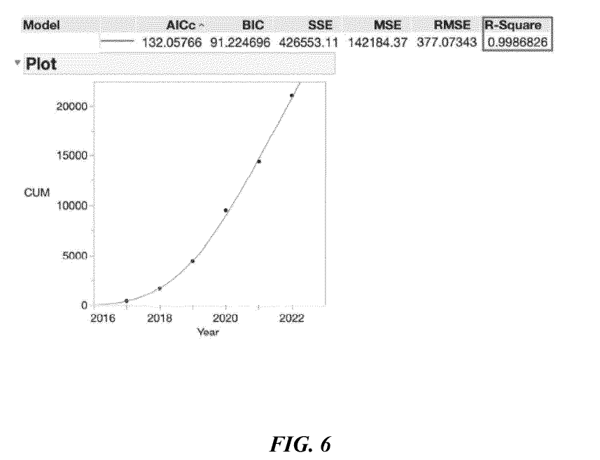

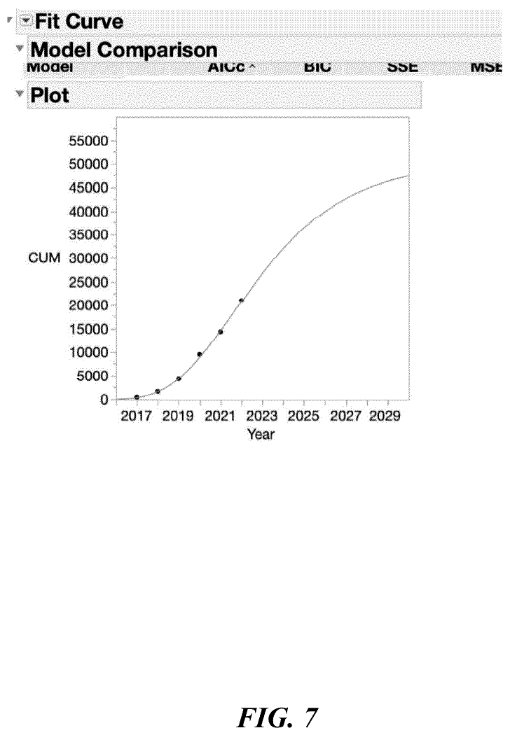

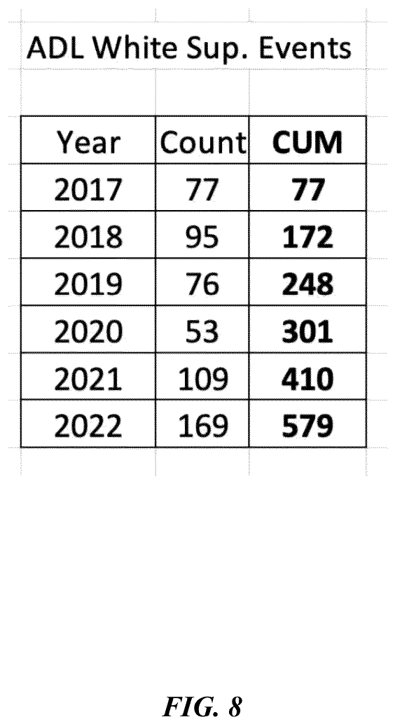

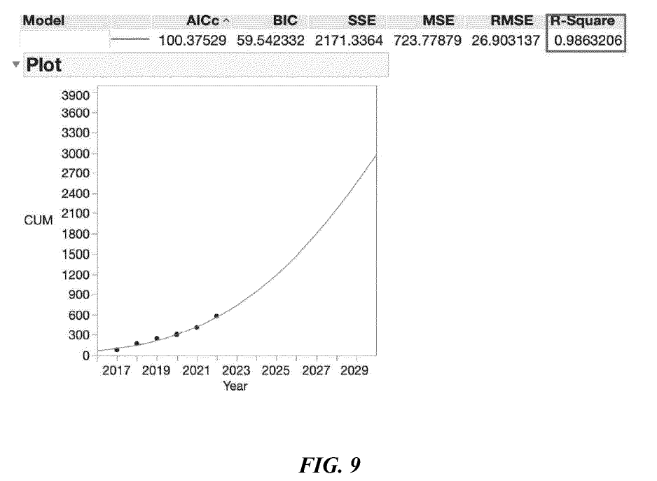

Mathematical modeling of data from the Anti-Defamation League's (a non-governmental organization) data was performed using the Gompertz 3-point model by JMP program version 15 (SAS, Cary, North Carolina, USA). Cumulated yearly data from three data subsets were modeled: antisemitic incidents, white nationalist propaganda, and white nationalist events. A universally accepted measure of goodness of fit, R² was calculated for each of these and quite surprisingly showed near perfect fits. (R² range is 0-1, with 1 indicating a perfect fit.) See FIGS. 1-9.

Example 2—US and non-governmental organization data on racially motivated hate crimes including murder and vandalism is modeled by linear, exponential, or sigmoid mathematical models in JMP or SPSS and measures of goodness of fit are high, enabling future predictions.

Example 3—Decision analysis, including decision trees (such as are shown in Chapter 5 Decision Analysis for Management Judgment 5th Edition by Paul Goodwin and George Wright. Wiley, West Sussex, UK) take inputs from the statistical analyses of JMP, or similar programs such as SPSS, and apply them to decisions model framework components including “decision utilities” and probabilities, to answer questions such as:

If current trends continue in the City of New York, should synagogues with greater than 500 congregants hire two full time security guards, invest in purchasing a $10,000 active shooter protection course, and buy new steel doors for all entrances, costing $7000?

If current trends continue in the southern USA, should authorities make plans to mitigate attacks against black churches in Georgia by recommending the presence of an armed guard at all events at southern black churches by 2025?

### Example 4—Ranking and Scoring System for Antisemitic Events

Sample Ranking of Antisemitic Actions
and calculation of a BIAS SCORE

| Rank | Action | Section |
|---|---|---|
| 1 | genocide (UN definition) | ultra |
| 2 | mass murder >10 people | ultra |
| 3 | mass murder 2-10 people | ultra |
| 4 | Individual Jew murdered due to hate | ultra |
| 5 | Jewish synagogue or community center | ultra |
| | building destroyed | |
| 6 | synagogue or community center attacked | high |
| 7 | street violence against Jew due to hate | high |
| 8 | antisemitic march >1000 people | high |
| 9 | antisemitic march <1000 people | medium |
| 10 | antisemitic radio or tv broadcast estimated | medium |
| | audience >10,000 | |
| 11 | property damaged (depends on the property) | low |
| 12 | property defaced | low |
| 13 | verbal insult | low |

| | Calculations samples | | |
|---|---|---|---|
| Rank | County #1 freq in 2022 | County #1 subtotals | |
| 13 | | | |
| 12 | | | |
| 11 | | | |
| 10 | 3 | 30 | |
| 9 | | | |
| 8 | 1 | 8 | |
| 7 | | | |
| 6 | 1 | 6 | |
| 5 | | | |
| 4 | | | |
| 3 | 5 | 15 | |
| 2 | | | |
| 1 | 10 | 10 | |
| | | 69 | =County #1 Total |
| Rank | County #2 freq in 2022 | County 1#2 subtotals | |
| 13 | | | |
| 12 | | | |
| 11 | | | |
| 10 | | | |
| 9 | | | |
| 8 | | | |
| 7 | 2 | 14 | |
| 6 | | | |
| 5 | | | |
| 4 | | | |
| 3 | 2 | 6 | |
| 2 | | | |
| 1 | 5 | 5 | |
| | | 25 | =County #2 Total |

Example 5—Artificial intelligence and machine learning algorithms take inputs from the statistical analyses of JMP or similar programs such as SPSS and apply them to decisions such as:

If current trends continue in the City of New York, should synagogue with greater than 500 congregants hire 2 full time security guards, invest in purchasing a $10,000 active shooter protection course, and buy new steel doors for all entrances, costing $7000.

If current trends continue in the southern USA, should authorities make plans to mitigate attacks against black churches in Georgia by recommending the presence of an armed guard at all events at southern black churches by 2025.

### Example 6—Example of Use of Shifted Gompertz Regression

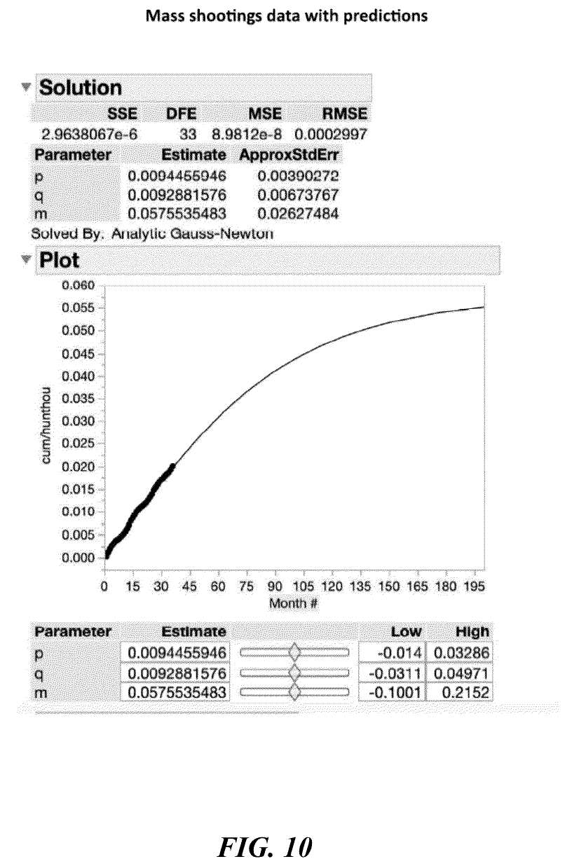

US Mass shooting data was obtained from Gun Violence Archive (gunviolencearchive.org. Accessed Jun. 3, 2023). FIG. 10 shows output from a regression on this data using the Shifted Gompertz Model. The thick line are the data points, and the thin line is the regression equation, which is extended out to the year 2030. An excellent fit was obtained. The parameters p and q were produced and can be further analyzed for their societal meaning and implications.

### Example 7—Sample Ranking System for Antisemitic Incidents

Weight=8 Incidents involving Persons
   Rank 4—Homicide offenses (Murder [Subdivisions of murder: genocide (UN definition), mass murder >10 people, mass murder 4-10 people, mass murder 2-3 persons, 1 person], non-negligent manslaughter, negligent manslaughter)
   Rank 3—Assault offenses (Aggravated assault, Simple assault, Intimidation)
   Rank 2—Human trafficking offenses (Commercial sex acts, Involuntary servitude)
   Rank 1—Kidnapping/abduction Sex offenses (Rape, Sodomy, Sexual assault with an object, Fondling, Incest, Statutory Rape)
Weight=4 Incidents involving Mass Movements of People
(subcategories below are further broken down and assigned a rank)
   (a) events-gatherings of antisemitic hate groups
   (b) migrations of individuals or groups,
   (c) military (e.g. government) and paramilitary (e.g. non-government militias) movements
Weight=2 Incidents involving Property
   Rank 5—Destruction/damage/vandalism of property/arson Burglary/breaking and entering
   Rank 4—Embezzlement/Extortion/blackmail/bribery
   Rank 3—Motor vehicle theft
   Rank 2—Fraud offenses (False pretenses/swindle/confidence game, Credit card/automated teller machine fraud, Impersonation Welfare fraud Wire fraud Identity theft, Hacking/computer invasion, Counterfeiting/forgery)
   Rank 1—Larceny/theft offenses (Pocket-picking, Purse-snatching Shoplifting, Theft from building, Theft from coin-operated machine or device, Theft from motor vehicle, Theft of motor vehicle parts, or accessories, Robbery, Stolen property offenses) All other larceny)
Weight=1 Incidents involving Speech
   (Subcategories include: verbal, written, online, broadcast (TV or radio) and each is assigned a rank.

### Example 8—Sample Ranking System for Bias Indicators for Classification of Hate Crimes

R14. The offender was previously involved in a similar hate crime or is a hate group member.
R13. There were indications that a hate group was involved. For example, a hate group claimed responsibility for the crime or was active in the neighborhood.
R12. Bias-related oral comments, written statements, or gestures were made by the offender indicating his or her bias. For example, the offender shouted a racial epithet at the victim.
R11. Bias-related drawings, markings, symbols, or graffiti were left at the crime scene. For example, a swastika was painted on the door of a synagogue, mosque, or LGBT center.
R10. Certain objects, items, or things which indicate bias were used. For example, the offenders wore white sheets with hoods covering their faces or a burning cross was left in front of the victim's residence.
R09. The incident coincided with a holiday or a date of significance relating to a particular race, religion, disability, sexual orientation, ethnicity, gender, or gen-der identity, for example, Martin Luther King Day, Rosh Hashanah, or the Transgender Day of Remembrance.
R08. The victim, although not a member of the targeted racial, religious, disability, sexual orientation, ethnicity, gender, or gender identity group, was a member of an advocacy group supporting the victim group.
R07. The victim was visiting a neighborhood where previous hate crimes had been committed because of race, religion, disability, sexual orientation, ethnicity, gender, or gender identity and where tensions remained high against the vic-tim's group.
R06. Several incidents occurred in the same locality, at or about the same time, and the victims were all of the same race, religion, disability, sexual orientation, ethnicity, gender, or gender identity.
R05. The victim was engaged in activities related to his or her race, religion, dis-ability, sexual orientation, ethnicity, gender, or gender identity. For example, the victim was a member of the National Association for the Advancement of Colored People (NAACP) or participated in an LGBT pride celebration.
R04. The offender and the victim were of a different race, religion, disability, sexual orientation, ethnicity, gender, and/or gender identity. For example, the victim was African American and the offender was White.
R03. The victim is a member of a specific group that is overwhelmingly outnumbered by other residents in the neighborhood where the victim lives and the incident took place.
R02. A substantial portion of the community, where the crime occurred, perceived that the incident was motivated by bias.
R01. A historically established animosity existed between the victim's and the offender's groups.

While the invention has been described in detail and with reference to specific examples thereof, it will be apparent to one skilled in the art that various changes and modifications can be made therein without departing from the spirit and scope thereof.

What is claimed is:

1. A method for classification of incidents and speech related to hate, intimidation, and bias against a person or group subject to bias, the method comprising:
receiving data related to incidents and/or speech related to hate, intimidation, and/or bias against a person and/or group subject to bias;
performing one or more steps including:
extracting sentences previously classified in a data repository of historical incident data from the received data,
extracting phrases and/or keywords previously classified in the data repository of historical incident data from the received data,
removing duplicates in the received data,
extracting keywords and phrases that are not found in the data repository,
identifying nouns and verbs in the received data,
constructing a word frequency table from the received data and/or a portion of the received data remaining after one or more of the above steps are performed, or
any combination thereof.

2. The method of claim 1, further comprising:
ranking and/or scoring the incidents and/or speech, of the received data, based on one or more outputs of the one or more steps.

3. The method of claim 1, wherein the received data includes a description of the incidents and/or speech related to hate, intimidation, and/or bias against a person and/or group subject to bias.

4. The method of claim 3, further comprising:
analyzing the description of the incidents and/or speech related to hate, intimidation, and/or bias to identify patterns, trends, and/or relationships between incidents and/or speech related to hate, intimidation, and/or bias against a person and/or group subject to bias.

5. The method of claim 4, wherein analyzing the description to identify patterns, trends, and/or relationships includes applying mathematical modeling.

6. The method of claim 4, wherein analyzing the description to identify patterns, trends, and/or relationships includes applying a machine learning model.

7. The method of claim 4, wherein the step of analyzing the description of incidents and speech related to hate, intimidation, and bias against a person or group subject to bias further comprises using mathematical decision analysis techniques.

8. The method of claim 4, wherein the step of analyzing the description of incidents and speech related to hate, intimidation, and bias against a person or group subject to bias further comprises using non-parametric tests selected from the group consisting of a Wilcoxon signed rank test, a Plackett-Luce model, and others.

9. The method of claim 4, wherein the step of analyzing the description of incidents and speech related to hate, intimidation, and bias against a person or group subject to bias further comprises using parametric tests selected from the group consisting of the Gompertz equation, and the shifted Gompertz equation.

10. The method of claim 4, further comprising:
using the identified patterns, trends, and/or relationships to predict future changes in incidents and/or speech related to hate, intimidation, and/or bias against a person and/or group subject to bias.

11. The method of claim 10, wherein the step of using the identified patterns, trends, and relationships to predict future changes in incidents and speech related to hate, intimidation, and bias against a person or group subject to bias further comprises providing a confidence level for the predicted future changes in incidents and speech related to hate, intimidation, and bias against a person or group subject to bias.

12. The method of claim 1, further comprising:
tracking changes in incidents and/or speech related to hate, intimidation and/or bias against a person and/or group subject to bias over time.

13. The method of claim 1, further comprising:
generating recommendations for interventions to mitigate the effects of incidents and/or speech related to hate, intimidation, and/or bias on a person and/or group subject to bias.

14. The method of claim 13, wherein the step of generating recommendations for interventions further comprises providing recommendations for interventions based on the predicted future changes in incidents and speech related to hate, intimidation, and bias against a person or group subject to bias.

15. The method of claim 1, further comprising:
generating recommendations for defending against incidents and/or speech related to hate, intimidation and/or bias.

16. The method of claim 15, wherein the step of generating recommendations for defending against incidents and speech related to hate, intimidation, and bias further comprises providing recommendations for defending against incidents and speech related to hate, intimidation, and bias based on the predicted future changes in incidents and speech related to hate, intimidation, and bias against a person or group subject to bias.

17. The method of claim 1, wherein the person or group subject to bias is subject to bias based upon age, race, ethnicity, religion, gender, sexual orientation, disability, socio-economic status or familial socio-economic status, citizenship status, association with institutions such as schools, charities, political organization, etc.

18. The method of claim 1, wherein the step of receiving data further comprises receiving data from multiple sources, including but not limited to sensors, databases, and external data feeds.
